(19) United States
(12) Patent Application Publication
(10) Pub. No.: US 2006/0159926 A1
(43) Pub. Date: Jul. 20, 2006

(54) Light refection sheet, process for producing the same and molding thereof

(75) Inventors: Keisuke Funaki, Chiba (JP); Masami Kogure, Chiba (JP); Hiroshi Akamine, Chiba (JP); Hiroshi Kawato, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Tokyo (JP)

(21) Appl. No.: 10/563,565

(22) PCT Filed: Mar. 2, 2004
(86) PCT No.: PCT/JP04/02560

§ 371 Date: Jan. 6, 2006

(30) Foreign Application Priority Data
Jul. 18, 2003 (JP) 2003-199083
Jul. 18, 2003 (JP) 2003-199082

(51) Int. Cl. B29C 47/76; B29C 47/14; B32B 27/36

(52) U.S. Cl. 428/412; 264/211; 264/102

(57) ABSTRACT

The light reflection sheet (I) of the present invention comprises a sheet having a thickness of 0.4 to 2 mm and comprising a polycarbonate resin composition containing (B) titanium oxide, and the sheet has a light reflectance of 98% or more and a light transmittance of less than 1%. It is excellent in a flame retardancy and a reflection characteristic. Also, the light reflection sheet (II) of the present invention is prepared by providing a light-fast layer which cuts or absorbs a UV ray in a thickness of 0.5 to 20 μm on at least one face of a base sheet having a thickness of 0.4 to 2 mm and comprising a PC resin composition containing a combination of 85 to 60 mass % of (A) a PC base polymer and 15 to 40 mass % of (B) titanium oxide. It is less yellowed and less reduced in a reflection characteristic even after used for a long period of time. Further, the light reflection sheet (III) of the present invention is prepared by providing a light diffusion layer which diffuses and reflects light in a thickness of 0.5 to 20 μm on at least one face of the same base sheet as in the light reflection sheet (II). It is improved in a light diffusing and reflecting property and can form a liquid crystal image plane having less luminance unevenness when it is used as a direct under type liquid crystal back light.

### TECHNICAL FIELD

The present invention relates to a light reflection sheet, a process for producing the same and a molding thereof. More specifically, it relates to a light reflection sheet having a thin thickness which uses a polycarbonate resin composition and is excellent in a flame retardancy and light reflection characteristics and which is suited to uses of reflection plates in a back light for liquid crystal and light source parts for lighting equipments, fluorescent lamps used in houses and various facilities, LED (light emitting diode), EL (electroluminescence), plasma and lasers, a process for producing the same and a molding thereof.

### BACKGROUND ART

In general, uses of a light reflection material include signboards, displays and liquid crystal back lights. Light reflection sheets which have so far been used include metal plates, metal foils, plastic sheets, metal-deposited products of plastic sheets and foamed and oriented PET films. However, there used to be the problems that the above sheets have less freedom of forms in molding and that cost is required for processing such as bending.

In recent years, uses of liquid crystal have brilliantly been expanded, and not only conventional uses of image planes of note type personal computers but also uses of particularly liquid crystal TV are expected to grow to a large extent. In the use of liquid crystal TV, a direct under type back light is used as a light source in order to realize a high luminance and a high fineness in middle-sized image planes and large-sized image planes of 508 mm (20 inches) or more, and various materials are proposed as reflection plates therefor. Laminates of foamed PET films or foamed PP films and Al plates and supercritical foamed PET sheets are used as a reflection plate for a direct under type back light for liquid crystal. Among them, articles obtained by folding foamed PET film/Al plate laminates are used in many cases.

Further, in recent years, proposed are a lot of techniques on light reflection materials such as blends with titanium oxide subjected to specific surface treatment making the best use of excellent mechanical characteristics (particularly an impact resistance), electrical characteristics, a transparency, a dimensional stability and a flame retardancy of a polycarbonate resin (refer to, for example, Japanese Patent Application Laid-Open No. 207092/1994 (1st page), Japanese Patent Application Laid-Open No. 316314/1997 (1st page) and Japanese Patent Application Laid-Open No. 316315/1997 (1st page)), blends with specific inorganic fillers (refer to, for example, Japanese Patent Application Laid-Open No. 242810/1995 (1st page)), blends with other polymers (for example, Japanese Patent Application Laid-Open No. 242781/1995 (1st page), Japanese Patent Application Laid-Open No. 242804/1995 (1st page), Japanese Patent Application Laid-Open No. 12869/1996 (1st page), Japanese Patent Application Laid-Open No. 302959/2000 (1st page) and Japanese Patent Application Laid-Open No. 12757/2000 (1st page)) and combinations with foamed products.

However, the above light reflection materials using the polycarbonate resins have been investigated principally in injection-molded parts and have not sufficiently been investigated in thermally moldable sheets which are required to be reduced in a thickness and large-scaled in a surface area as is the case with back lights for liquid crystal.

Further, when the above polycarbonate resin compositions are extruded to prepare molded sheets, not only a high reflectivity but also a high shading property are required in optical characteristics in light reflection uses such as reflection plates for back lights in liquid crystal displays, and therefore titanium oxide has to be blended in a high concentration. However, if titanium oxide is blended in a high concentration, a deterioration in a polycarbonate resin matrix is brought about, and therefore the problem that a light reflectance of the resin molded article is reduced has been caused.

Further, if titanium oxide is blended in a large quantity, polycarbonate is decreased in a molecular weight to a large extent, and a reduction in the mechanical strength is not avoided. Proposed are polycarbonate resin compositions blended with titanium oxide which are improved in the above problem and have a good mechanical strength and which are endowed with excellent optical characteristics (refer to, for example, Japanese Patent Application Laid-Open No. 320519/1993 (1st page)). However, the above characteristics have to be further improved in order to satisfy such requirements of the market as observed in reflection plates for back lights in liquid crystal displays.

Further, polycarbonate resins containing titanium oxide in a large quantity have the problem that failures such as draw resonance, rough surface and adhesion to a roll in an extruding step and foaming and an uneven thickness in thermal molding are liable to be brought about in producing sheets and products. Thus, requirement to establish a production process in which the problems described above are improved is raised more and more for a reduction in a thickness and an increase in a surface area in light reflection sheets and plates for liquid crystal displays.

A polycarbonate resin has a higher oxygen index among various thermoplastic resins and is usually called a resin having a self-extinguishing property. It is known that a polycarbonate-polyorganosiloxane copolymer or a mixture of a polycarbonate-polyorganosiloxane copolymer and a polycarbonate resin shows usually a higher flame retardant performance than that of the polycarbonate resin. However, a level of a flame retardancy required in the light reflection field is usually as high as V-0 in the UL94 standard, and a flame retardant and a flame retardant aid are usually added in order to provide a flame retardancy satisfying the above level. It has usually been considered to be difficult to make a flame retardancy consistent with a high reflectivity in molded articles having a thin thickness of 1 mm or less required to reflection plates for back lights in liquid crystal displays.

Accordingly, required to be improved are thermally moldable thin sheets using a polycarbonate resin composition which show a flame retardancy without adding a phosphorus base flame retardant and a halogen base flame retardant while maintaining a heat resistance and which satisfy a high reflectivity and a high shading property and are excellent in a light reflecting characteristic, thermally molded articles and production processes for the same.

Further, in recent years, proposed are a lot of techniques on light reflection materials (injection-molded articles) such as blends with specific inorganic fillers, blends with other polymers and combinations with foamed products making the best use of excellent characteristics of a polycarbonate resin (PC resin). Superiority of a PC resin thermally molded reflection plate against those of conventional PET film/Al plate folding processed articles includes easiness of designing the form of the plates in processing the resin as compared with that in processing metals, easiness of reflecting optical design, a light weight and an advantageous processing cost.

In a direct under type liquid crystal back light, a reflection plate is used close to plural light sources (cold cathode tubes), so that a light fastness against the wavelengths of the light sources is required. A UV ray having a wavelengths of 200 to 400 nm in addition to light of a visible region used as a liquid crystal light source is irradiated from the cold cathode tubes, and this UV ray accelerates optical degradation of the reflection member. A resin constituting the reflection plate is yellowed as the optical degradation proceeds, and the reflection plate is reduced in a reflection characteristic. Accordingly, a mixing type light stabilizer for providing a light fastness and a coating technique are proposed in a white PET film (refer to, for example, Japanese Patent Application Laid-Open No. 228313/2001, Japanese Patent Application Laid-Open No. 40214/2002 and Japanese Patent Application Laid-Open No. 90515/2002).

On the other hand, techniques of providing a light fastness by coating have so far been available as well in PC resin-made reflection sheets, but cracking of the coating layer by deformation and unevenness of the surface by heating are brought about in thermal molding of conventional PC, and it has been difficult to apply them to light reflection plates. Further, from the viewpoint of a chemical resistance of PC, the range of coating agents which can be used for PC is narrower than in PET films, and this has made it difficult to apply the techniques of the PET films.

Further, in a direct under type liquid crystal back light, a reflection plate is used close to plural light sources (cold cathode tubes), and bright parts and dark parts are liable to be produced according to the positions of the light sources in a material having strong specular reflection (it is also called regular reflection and has a narrow distribution of a reflection angle, that is, the reflected light is directional), and therefore when observed through a liquid crystal image plane, they cause an unevenness in the luminance. A method for removing the above unevenness in the luminance includes a method in which an unevenness in the luminance is removed by form design of a reflection plate and structure design of a back light unit in addition to a reduction in a specular reflectivity of the reflection plate. When the specular reflectivity is reduced, the reflectance tends to be lowered. The users have various needs to the reflection characteristic, and therefore a reduction in the specular reflectivity is not necessarily a method satisfying all users.

On the other hand, it is proposed in a white PET film to enhance a light diffusion reflectivity by adding particles to a light-fast coating layer (refer to, for example, Japanese Patent Application Laid-Open No. 40214/2002). In general, a PC resin-made reflection sheet has a higher specular reflectivity than that of a white PET film, and therefore it is difficult to apply the techniques of the white PET film as they are. Further, the coating layer is spread by thermal molding, and therefore it becomes more difficult than in white PET to control a coating surface thereof.

### DISCLOSURE OF THE INVENTION

An object of the present invention is to provide a light reflection sheet (I) of a thin thickness which solves the foregoing problems of conventional techniques and uses a polycarbonate resin and which has a flame retardancy, a high reflectivity and a high shading property and is excellent in a light reflecting characteristic and a molded article thereof, and another object is to provide a production process for the above light reflection sheet having less dispersion of quality in a thickness and the like.

Also, an object of the present invention is to provide a light reflection sheet (II) which is less yellowed and less reduced in a reflection characteristic even after used for a long period of time and which can be thermally molded as is the case with a single layer sheet comprising a polycarbonate resin composition and a molded article thereof.

Further, an object of the present invention is to provide a light reflection sheet (III) which is improved in a light diffusion reflectivity and can form a liquid crystal image plane having less uneven luminance when used in the form of a direct under type liquid crystal back light and which can be thermally molded as is the case with a single layer sheet comprising a polycarbonate resin composition and a molded article thereof.

In light of the situations described above, intensive investigations repeated by the present inventors have resulted in finding that it is effective to combine a specific polycarbonate resin composition with limited production conditions.

Also, the present inventors have found that a light reflection sheet (II) which is less yellowed and less reduced in a reflection characteristic even after used for a long period of time and which can be thermally molded as is the case with a single layer sheet comprising a polycarbonate resin composition is obtained by providing a light-fast layer which cuts or absorbs a UV ray on at least one face of a base sheet comprising a specific polycarbonate resin composition.

Further, the present inventors have found that a light reflection sheet (III) which is improved in a light diffusion reflectivity and can form a liquid crystal image plane having less uneven luminance when used in the form of a direct under type liquid crystal back light and which can be thermally molded as is the case with a single layer sheet comprising a polycarbonate resin composition is obtained by providing a light diffusion layer which diffuses and reflects light on at least one face of a base sheet comprising a specific polycarbonate resin composition.

The present invention has been completed based on the above knowledges.

That is, the present invention involves the following contents as essentials.

[1] A light reflection sheet (I) comprising a sheet having a thickness of 0.4 to 2 mm and comprising a polycarbonate resin composition containing (B) titanium oxide, wherein the above sheet has a light reflectance of 98% or more and a light transmittance of less than 1%.

[2] The light reflection sheet as described in the above item [1], wherein the polycarbonate resin composition comprises 85 to 60 mass % of (A) a polycarbonate base polymer and 15 to 40 mass % of (B) titanium oxide.

[3] The light reflection sheet as described in the above item [1] or [2], having a flame retardancy of a V-0 class in a thickness of 0.8 mm in a vertical flame retardant test according to a UL94 method.

[4] A production process for the light reflection sheet as described in any of the above items [1] to [3], comprising a step (1) of drying a polycarbonate resin composition containing 85 to 60 mass % of (A) a polycarbonate base polymer and 15 to 40 mass % of (B) titanium oxide at 120 to 140° C. for 2 to 10 hours, a step (2) of extruding it by means of an extruding machine equipped with a volatile removing device and a step (3) of molding it into a sheet at a dice temperature of 200 to 260° C. and a roll temperature of 120 to 180° C.

[5] A molded article prepared by heating the light reflection sheet as described in any of the above items [1] to [3] at a temperature of 160 to 200° C. and then thermally molding it at a spreading magnification of 1.1 to 2 times.

[6] A molded article prepared by thermally molding the light reflection sheet as described in any of the above items [1] to [3], wherein an unevenness in a thickness of a reflecting surface is 0.2 mm or less.

[7] A light reflection sheet (II) prepared by providing a light-fast layer which cuts or absorbs a UV ray in a thickness of 0.5 to 20 μm on at least one face of a base sheet having a thickness of 0.4 to 2 mm and comprising a polycarbonate resin composition containing a combination of 85 to 60 mass % of (A) a polycarbonate base polymer and 15 to 40 mass % of (B) titanium oxide.

[8] The light reflection sheet as described in the above item [7], wherein the light-fast layer is constituted from an acryl base resin or a methacryl base resin copolymerized with at least one selected from a polymerizable light stabilizer component and a polymerizable UV absorber component.

[9] The light reflection sheet as described in the above item [8], wherein the polymerizable light stabilizer component and the polymerizable UV absorber component contain at least one selected from hindered amine base compounds, benzotriazole base compounds and benzophenone base compounds.

[10] The light reflection sheet as described in any of the above items [7] to [9], wherein a reflectance measured by irradiating the surface of the light-fast layer with light of a visible light region wavelength is 90% or more.

[11] The light reflection sheet as described in any of the above items [7] to [10], wherein a color difference (ΔE) between before and after irradiation which is observed when irradiating the surface of the light-fast layer with a UV ray in an energy amount of 20 J/cm² by means of a high pressure mercury lamp is 10 or less, and a reduction in a reflectance of visible light is 5% or less.

[12] A molded article obtained by thermally molding the light reflection sheet as described in any of the above items [7] to [11].

[13] A light reflection sheet (III) prepared by providing a light diffusion layer which diffuses and reflects light in a thickness of 0.5 to 20 μm on at least one face of a base sheet having a thickness of 0.4 to 2 mm and comprising a polycarbonate resin composition containing a combination of 85 to 60 mass % of (A) a polycarbonate base polymer and 15 to 40 mass % of (B) titanium oxide.

[14] The light reflection sheet as described in the above item [13], wherein the light diffusion layer is a layer in which particles having an average particle diameter of 1 to 20 μm selected from organic particles and inorganic particles are dispersed in an acryl base resin or a methacryl base resin.

[15] The light reflection sheet as described in the above item [14], wherein the organic particles are particles selected from acryl base cross-linked particles and styrene base cross-linked particles; the inorganic particles are particles selected from silica and titanium oxide; and a content of the above particles is 0.5 to 50 mass % based on the light diffusion layer.

[16] The light reflection sheet as described in any of the above items [13] to [15], wherein a reflectance measured by irradiating the surface of the light diffusion layer with light of a visible light region wavelength is 90% or more.

[17] The light reflection sheet as described in any of the above items [13] to [16], wherein a difference between a total reflectance (SCI) measured by irradiating the surface of the light diffusion layer with light of a visible light region wavelength and a reflectance (SCE) obtained by deducting specular reflection from total reflection is 4% or less.

[18] The light reflection sheet as described in any of the above items [13] to [17], wherein the light diffusion layer contains at least one selected from a polymerizable light stabilizer component and a polymerizable UV absorber component, and the above components are selected from hindered amine base compounds, benzotriazole base compounds and benzophenone base compounds.

[19] The light reflection sheet as described in any of the above items [13] to [18], wherein a color difference (ΔE) between before and after irradiation which is observed when irradiating the surface of the light diffusion layer with a UV ray in an energy amount of 20 J/cm² by means of a high pressure mercury lamp is 10 or less, and a reduction in a reflectance of visible light is 5% or less.

[20] A molded article obtained by thermally molding the light reflection sheet as described in any of the above items [13] to [19].

### BRIEF DESCRIPTIONS OF THE DRAWINGS

FIG. 1 is a partial vertical sectional drawing of a reflecting surface of a reflection plate molded article used for direct under type lighting.

FIG. 2 is a perspective drawing showing the form of a thermally molded article produced in Example 19 and Example 27.

The number 1 shows a reflection plate; 2 shows a light source-receiving groove; 3 shows a multi-bending surface; and 4 shows a curved part.

### BEST MODE FOR CARRYING OUT THE INVENTION

First, the light reflection sheet (I) of the present invention shall be explained. The preferred polycarbonate resin composition (hereinafter abbreviated as the PC resin composition) (I) used for the light reflection sheet (I) of the present invention is constituted from:

(A): 85 to 60 mass % of a polycarbonate base polymer

(B): 15 to 40 mass % of titanium oxide

(C): 0 to 1.0 mass part of polytetrafluoroethylene having a fibril-forming ability and

(D): 0.05 to 2 mass parts of organopolysiloxane, wherein (A)+(B) is 100 mass parts.

The polycarbonate base polymer (A) is preferably a mixture of (A-1) a polycarbonate-polyorganosiloxane copolymer and (A-2) a polycarbonate resin. The polycarbonate-polyorganosiloxane copolymer (A-1) (hereinafter abbreviated as the PC-POS copolymer) includes various ones and it comprises preferably a polycarbonate part having a repeating unit of a structure represented by the following Formula (1): 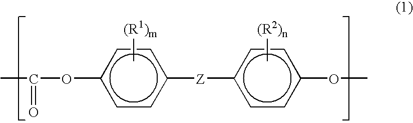
[wherein R¹ and R² each are a halogen atom (for example, chlorine, fluorine and iodine) or an alkyl group having 1 to 8 carbon atoms (for example, methyl, ethyl, propyl, isopropyl, various butyls (n-butyl, isobutyl, sec-butyl and tert-butyl), various pentyls, various hexyls, various heptyls and various octyls); m and n each are an integer of 0 to 4; when m is 2 to 4, R¹ may be the same as or different from each other, and when n is 2 to 4, R² may be the same as or different from each other; and Z represents an alkylene group having 1 to 8 carbon atoms or an alkylidene group having 2 to 8 carbon atoms (for example, methylene, ethylene, propylene, butylene, pentelylene, hexylene, ethylidene and isopropylidene), a cycloalkylene group having 5 to 15 carbon atoms or a cycloalkylidene group having 5 to 15 carbon atoms (for example, cyclopentylene, cyclohexylene, cyclopentylidene and cyclohexylidene), a single bond, —SO₂—, —SO—, —S—, —O—, —CO— bonds or a bond represented by the following Formula (2) or Formula (2′): 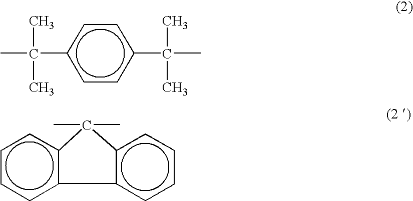
] and a polyorganosiloxane part having a repeating unit of a structure represented by the following Formula (3): 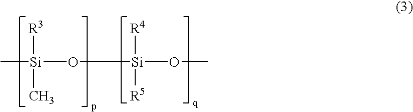
[wherein R³, R⁴ and R⁵ each are a hydrogen atom, an alkyl group having 1 to 5 carbon atoms (for example, methyl, ethyl, propyl, n-butyl and isobutyl) or a phenyl group; p and q each are an integer of 0 or 1 or more, and the total of p and q is an integer of 1 or more]. In this case, a polymerization degree of the polycarbonate part is preferably 3 to 100, and a polymerization degree of the polyorganosiloxane part is preferably 2 to 500.

The PC-POS copolymer described above is a block copolymer comprising the polycarbonate part having the repeating unit of the structure represented by Formula (1) described above and the polyorganosiloxane part having the repeating unit of the structure represented by Formula (3) described above, and it has an average viscosity molecular weight of preferably 10,000 to 40,000, more preferably 12,000 to 35,000. The above PC-POS copolymer can be produced by, for example, dissolving a polycarbonate oligomer (hereinafter abbreviated as the PC oligomer) produced in advance which constitutes the polycarbonate part and polyorganosiloxane (for example, polydialkylsiloxane such as polydimethylsiloxane (PDMS) and polydiethylsiloxane and polymethylphenylsiloxane) which has a reactive group at an end and constitutes the polyorganosiloxane part in a solvent such as methylene chloride, chlorobenzene and chloroform and adding thereto a sodium hydroxide aqueous solution of bisphenol A to carry out interfacial polycondensation reaction using triethylamine and trimethylbenzylammonium chloride as a catalyst. Further, PC-POS copolymers produced by a method described in Japanese Patent Publication No. 30105/1969 and a method described in Japanese Patent Publication No. 20510/1970 can be used as well.

In this case, the PC oligomer having the repeating unit represented by Formula (1) can readily be produced by a solvent method, that is, by reacting divalent phenol represented by the following Formula (4): 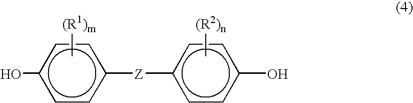
[R¹, R², Z, m and n are the same as in Formula (1) described above] with a carbonate precursor such as phosgene in a solvent such as methylene chloride under the presence of an acid receptor and a molecular weight controller which are publicly known. That is, it can be produced by reacting divalent phenol with a carbonate precursor such as phosgene in a solvent such as methylene chloride under the presence of an acid receptor and a molecular weight controller which are publicly known. It can be produced as well by transesterification reaction of divalent phenol with a carbonate precursor such as a carbonic acid ester compound.

Various compounds can be given as the divalent phenol represented by Formula (4) described above. In particular, 2,2-bis(4-hydroxyphenyl)propane (generally called bisphenol A) is preferred. The divalent phenols other than bisphenol A include, for example, bis(4-hydroxyphenyl)alkanes such as bis(4-hydroxyphenyl)methane, 1,1-bis(4-hydroxyphenyl)ethane and 1,2-bis(4-hydroxyphenyl)ethane, bis(4-hydroxyphenyl)cycloalkanes such as 1,1-bis(4-hydroxyphenyl)cyclohexane and 1,1-bis(4-hydroxyphenyl)cyclodecane, 4,4′-dihydroxydiphenyl, bis(4-hydroxyphenyl)oxide, bis(4-hydroxyphenyl)sulfide, bis(4-hydroxyphenyl)sulfone, bis(4-hydroxyphenyl)sulfoxide, bis(4-hydroxyphenyl)ether and bis(4-hydroxyphenyl)ketone. In addition thereto, the divalent phenols include hydroquinone. The above divalent phenols each may be used alone or in a mixture of two or more kinds thereof.

The carbonic ester compound include, for example, diaryl carbonates such as diphenyl carbonate and dialkyl carbonates such as dimethyl carbonate and diethyl carbonate. In reacting the divalent phenol with the carbonate precursor each described above to produce polycarbonate, a molecular weight controller can be used if necessary. This molecular weight controller shall not specifically be restricted, and compounds which have so far been conventionally used in the production of polycarbonate can be used. Such compounds include, for example, monovalent phenol such as phenol, p-cresol, p-tert-butylphenol, p-tert-octylphenol, p-cumylphenol, p-nonylphenol and p-dodecylphenol.

In the present invention, the PC oligomer used for producing the PC-POS copolymer may be a homopolymer prepared by using one kind of the divalent phenols described above or a copolymer prepared by using two or more kinds thereof. Further, it may be thermoplastic random branched polycarbonate obtained by using a multifunctional aromatic compound in combination with the divalent phenols described above.

In order to produce the PC-POS copolymer having a n-hexane soluble content of 1.0 mass % or less, a content of polyorganosiloxane in the copolymer is preferably controlled to 10 mass % or less; the copolymer in which the number of the repeating unit represented by Formula (3) is 100 or more is preferably used; and the copolymerization described above is preferably carried out in the presence of 3×10⁻³ mole/(kg of the oligomer) of a catalyst such as tertiary amine.

Next, the polycarbonate resin which is the component (A-2) constituting the PC resin composition according to the present invention can readily be produced, for example, by reacting divalent phenol with phosgene or a carbonic acid ester compound. That is, it can be produced, for example, by reacting divalent phenol with a carbonate precursor such as phosgene in a solvent such as methylene chloride under the presence of an acid receptor and a molecular weight controller which are publicly known or by transesterification reaction of divalent phenol with a carbonate precursor such as a carbonic ester compound in the presence or the absence of a solvent. In this case, the divalent phenol may be the same as or different from the compound represented by Formula (4) described above.

The same compounds as described above can be used as the carbonic acid ester compound and the molecular weight controller.

The polycarbonate resin (A-2) may be a homopolymer prepared by using one kind of the divalent phenols described above or a copolymer prepared by using two or more kinds thereof. Further, it may be a thermoplastic random branched polycarbonate resin obtained by using a multifunctional aromatic compound in combination with the divalent phenol described above. In general, the multifunctional aromatic compound is called a branching agent, and it includes, to be specific, 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, fluoroglucine, trimellitic acid and isatinbis(o-cresol).

The polycarbonate resin (A-2) having a viscosity average molecular weight falling in a range of 13,000 to 30,000, particularly 15,000 to 25,000 is preferred from the viewpoint of a mechanical strength, particularly an Izod impact strength and a moldability. The viscosity average molecular weight (Mv) is a value calculated from an equation of [η]=1.23×10⁻⁵ Mv^{0.83}, wherein a viscosity of the methylene chloride solution at 20° C. is measured by means of a Ubbelohde viscometer, and the limiting viscosity [η] is determined from this.

The polycarbonate resin having the above characteristics is commercially available in the form of, for example, an aromatic polycarbonate resin such as Tarflon FN3000A, FN2500A, FN2200A, FN1900A, FN1700A and FN1700A (brand names, manufactured by Idemitsu Petrochemical Co., Ltd.).

In the light reflection sheet (I) of the present invention, a blend proportion of the component (A-1) out of the components (A) is 5 to 85 mass parts, preferably 10 to 58 mass parts per total 100 mass parts of the respective components of (A)+(B), and a blend proportion of the component (A-2) is 0 to 80 mass parts, preferably 10 to 75 mass parts. If a blend proportion of the component (A-1) is less than 5 mass parts, polyorganosiloxane is deteriorated in dispersibility, and the satisfactory flame retardancy is not obtained. In contrast with this, if the blend proportions of the component (A-1) and the component (A-2) fall in the preferred ranges, the sheet having a good flame retardancy is obtained. A content of the polyorganosiloxane part in PC-POS may be selected according to the level of a flame retardancy required to the final resin composition. A proportion of the polyorganosiloxane part in the component (A-1) is preferably 0.3 to 10 mass %, more preferably 0.5 to 5 mass % based on the total amount of the component (A-1) and the component (A-2). In this regard, if it is less than 0.3 mass %, it is likely that the satisfactory oxygen index is not obtained and that the intended flame retardancy is not revealed. On the other hand, if it exceeds 10 mass %, a heat resistance of the resin is likely to be notably reduced, which results in an increase in the cost of the resin. If it falls in the preferred range, more suitable oxygen index is obtained, and the sheet having an excellent flame retardancy is obtained. In this case, a polyorganosiloxane component contained in organosiloxane which is a component (D) described later is not included in “polyorganosiloxane” and excluded therefrom.

Titanium oxide which is the component (B) in the present invention is used in the form of fine powder for the purpose of providing the polycarbonate resin with a high reflectivity and a low transparency, that is, a high shading property. Titanium oxide of fine powder having various particle sizes can be produced by either a chlorine process or a sulfuric acid process. Titanium oxide used in the present invention may be either of a rutile type and an anatase type, and the rutile type is preferred in terms of a heat stability and a weatherability. The form of the fine powder particles shall not be restricted, and the flaky, spherical or amorphous particles can suitably be selected and used.

Titanium oxide used as the component (B) is preferably subjected to surface treatment with hydroxide hydrates of aluminum and/or silicon and in addition thereto, amine compounds and polyol compounds. This treatment elevates the homogeneous dispersibility in the PC resin composition (I) and a stability of the dispersion state and in addition thereto, enhances as well the affinity with the flame retardant added, and therefore it is preferred in terms of producing the homogeneous composition. Alumina hydrate, silica hydrate, triethanolamine and trimethylolethane can be given as the examples of the hydroxide hydrates of aluminum and silicon, the amine compounds and the polyol compounds which are referred to above. A treating method itself in the surface treatment described above shall not specifically be restricted, and an optional method can be adopted. An amount of the surface treating agent given to the particle surface of titanium oxide by the above treatment shall not specifically be restricted, and it is suitably 0.1 to 10.0 mass % based on titanium oxide considering a light reflectivity of titanium oxide and a moldability of the PC resin composition (I).

In the PC resin composition (I) according to the present invention, a particle diameter of the titanium oxide powder described above which is used as the component (B) shall not specifically be restricted, and the powder having an average particle diameter of 0.1 to 0.5 μm is suitable for efficiently exhibiting the effects described above. A blending amount of titanium oxide in the PC resin composition (I) according to the present invention is 15 to 40 mass parts, preferably 20 to 40 mass parts per total 100 mass parts of the respective components of (A)+(B). If the blending amount is smaller than 15 mass parts, the shading property is unsatisfactory, and the light reflectance is reduced to a large extent. Accordingly, it is not preferred. On the other hand, if the blending amount exceeds 40 mass parts, pelletization by kneading and extruding becomes difficult, and it becomes difficult as well to mold and process the resin, so that a lot of silver tends to be produced on the molded article. A shading property and a high reflectivity are required particularly to a reflecting plate and a reflecting frame used for back lights in uses of liquid crystal TV sets and monitors, and therefore a blending amount of the component (B) is more preferably 20 to 35 mass parts.

A surface acid amount of titanium oxide used in the present invention is preferably 10 micomole/g or more, and a surface base amount thereof is preferably 10 micomole/g or more. If the surface acid amount is smaller than 10 micomole/g or the surface base amount is smaller than 10 micomole/g, a reactivity thereof with the organosiloxane compound which is the stabilizer is reduced, so that titanium oxide is likely to be unsatisfactorily dispersed, and the molded article is likely to be insufficiently increased in a luminance. A surface acid amount of titanium oxide used in the present invention is more preferably 15 micomole/g or more, further preferably 16 micomole/g or more, and a surface base amount thereof is more preferably 20 micomole/g or more, further preferably 25 micomole/g or more.

A surface acid amount and a surface base amount of titanium oxide are measured by potentiometric titration in a nonaqueous solution. To be specific, the surface acid amount is measured by dispersing titanium oxide in an MIBK (methyl isobutyl ketone) solution of n-propylamine of 1/100 normal and subjecting the supernatant to potentiometric titration using an MIBK solution of perchloric acid of 1/100 normal. Also, the surface base amount is measured by dispersing titanium oxide in an MIBK (methyl isobutyl ketone) solution of acetic acid of 1/100 normal and subjecting the supernatant to potentiometric titration using an MIBK solution of potassium methoxide of 1/100 normal.

If the PC resin composition according to the present invention is blended with polytetrafluoroethylene (hereinafter abbreviated as “PTFE”) having a fibril-forming ability as the component (C), the melt dropping prevention effect can be endowed if necessary, and the high flame retardancy can be provided. An average molecular weight of PTFE is preferably 500,000 or more, more preferably 500,000 to 10,000,000 and further preferably 1,000,000 to 10,000,000. An amount of the component (C) is preferably 0 to 1.0 mass part, more preferably 0.1 to 0.5 mass part per total 100 mass parts of the component (A) and the component (B). If this amount exceeds 1.0 mass part, not only adverse effects are exerted on the impact resistance and the appearance of the molded article, but also discharge of the strand is pulsed in kneading and extruding, and it is likely that the stable pellets can not be produced. If the amount falls in the range described above, the melt dropping prevention effect is provided, and the sheet having an excellent flame retardancy is obtained.

Polytetrafluoroethylene (PTFE) having a fibril-forming ability shall not specifically be restricted, and those classified into Type 3 in ASTM Standards can be used. Those classified into this type include, to be specific, Teflon 6-J (brand name: manufactured by Mitsui Du Pont Fluorochemicals Co., Ltd.) and Polyflon D-1 and Polyflon F-103 (brand names: manufactured by Daikin Industries Ltd.). Those excluding Type 3 include Argoflon F5 (brand name: manufactured by Montefluos Co., Ltd.) and Polyflon MPA FA-100 (brand name: manufactured by Daikin Industries Ltd.). These PTFE may be used in combination of two or more kinds thereof.

Polytetrafluoroethylene (PTFE) described above having a fibril-forming ability can be obtained, for example, by polymerizing tetrafluoroethylene in an aqueous solvent at a pressure of 0.007 to 0.7 MPa and a temperature of 0 to 200° C., preferably 20 to 100° C. in the presence of sodium, potassium or ammonium peroxysulfide.

The PC resin composition (I) according to the present invention is preferably blended with organosiloxane as the component (D) in terms of preventing degradation of the resin and maintaining the characteristics of the resin such as a mechanical strength, a stability and a heat resistance. To be specific, it includes alkyl hydrogen silicon and alkoxysilicon.

Alkyl hydrogen silicon includes, for example, methyl hydrogen silicon and ethyl hydrogen silicon. Alkoxysilicon includes, for example, methoxysilicon and ethoxysilicon. Particularly preferred alkoxysilicon is, to be specific, a silicon compound containing an alkoxysilyl group in which an alkoxy group is bonded to a silicon atom directly or via a divalent hydrocarbon group, and it includes, for example, linear, cyclic, reticular and partially branched linear organopolysiloxanes. In particular, linear organopolysiloxanes are preferred. To be more specific, organopolysiloxanes having a molecular structure in which an alkoxy group is bonded to a silicon principal chain via a methylene chain are preferred.

SH1107, SR2402, BY16-160, BY16-161, BY16-160E and BY16-161E (brand names, manufactured by Dow Corning Tray Co., Ltd.) can suitably be used as organosiloxane which is the above component (D).

An addition amount of this organosiloxane falls, though depending on an addition amount of titanium oxide, preferably in a range of 0.05 to 2.0 mass parts per total 100 mass parts of the respective components of (A)+(B). If this amount is less than 0.05 mass part, deterioration of the polycarbonate resin is brought about, and the resin is likely to be reduced in a molecular weight. On the other hand, if it exceeds 2.0 mass parts, a rise in the effect is not observed so much in proportion to the addition amount, and it is economically disadvantageous. In addition thereto, silver is produced on the surface of the molded article, and the appearance of the product is likely to be deteriorated.

The PC resin composition (I) according to the present invention can be blended, if necessary, with various flame retardants, inorganic fillers, additives, other synthetic resins and elastomers in addition to the respective components of (A), (B), (C) and (D) described above as long as the objects of the present invention are not damaged. First, the flame retardants include phosphorus base compounds and bromine base compounds. The composition used in the present invention can already sufficiently secure a flame retardancy by combining the polycarbonate-polyorganosiloxane copolymer of the component (A-1) with the polycarbonate resin of the component (A-2), but when the flame retardancy is further required, the flame retardants can be used, if necessary, in a range of less than 0.5 mass, preferably less than 0.3 mass part per 100 mass parts of the components of (A)+(B).

When a phosphorus base compound is added as the flame retardant, the fluidity is elevated, but the problem that a reflectance and a heat resistance of the sheet are reduced is involved therein. When a bromine base compound is used as the flame retardant, there is the defect that the heat stability is usually lowered.

Phosphoric acid ester compounds are preferred as the flame retardants of a phosphorus base compound. The specific examples thereof include trimethyl phosphate, triethyl phosphate, tributyl phosphate, trioctyl phosphate, tributoxyethyl phosphate, triphenyl phosphate, tricresyl phosphate, cresyldiphenyl phosphate, octyldiphenyl phosphate, tri(2-ethylhexyl)phosphate, diisopropylphenyl phosphate, trixylenyl phosphate, tris(isopropylphenyl)phosphate, trinaphthyl phosphate, bisphenol A bisphosphate, hydroquinone bisphosphate, resorcin bisphosphate, resorcinol diphenyl phosphate, trioxybenzene triphosphate and cresyldiphenyl phosphate. Further, They include compounds obtained by introducing various substituents into the above compounds and oligomers and polymers thereof. The above phosphoric acid ester compounds may be used alone or in combination of two or more kinds thereof.

Capable of being given as the flame retardants of a bromine base compound are, for example, brominated bisphenol A type epoxy polymers, pentabromobenzyl acrylate, brominated polycarbonate oligomers, triazine base flame retardants, tetrabromobisphenol A, bis(tribromophenoxy)ethane, tetrabromobisphenol A-bis(2-hydroxyethyl ether), tetrabromobisphenol A-bis(2,3-dibromopropyl ether), tetrabromobisphenol A-bis(allyl ether), hexabromocyclododecane, polydibromophenylene oxide and brominated phthalic acid esters. The above bromine base compounds may be used alone or in combination of two or more kinds thereof.

The inorganic fillers described above which are blended for the purposes of a rise in a mechanical strength and a durability of the PC resin composition (I) or an increase in a volume thereof include, for example, glass fibers (GF), carbon fibers, glass beads, glass flakes, carbon black, calcium sulfate, calcium carbonate, calcium silicate, alumina, silica, asbestos, talc, clay, mica and quartz powder. The additives described above include, for example, antioxidants such as phosphorus bases, hindered phenol bases and amine bases, UV absorbers such as benzotriazole bases and benzophenone bases, external lubricants such as aliphatic carboxylic acid ester bases, paraffin bases, silicon oils and polyethylene waxes, mold releasing agents, antistatic agents and coloring matters. The other synthetic resins include respective resins such as polyethylene, polypropylene, polystyrene, AS resins (acrylonitrile-styrene copolymers), ABS resins (acrylonitrile-butadiene-styrene copolymers) and polymethyl methacrylate. The elastomers include isobutylene-isoprene rubbers, styrene-butadiene rubbers, ethylene-propylene rubbers and acryl base elastomers.

The light reflection sheet (I) of the present invention is molded in the following manner. First, the PC resin composition (I) described above is dried usually at 120 to 140° C. for 2 to 10 hours (drying step); it is extruded by means of an extruding machine equipped with a volatile removing device (extruding step); and a sheet is molded at a dice temperature of 200 to 260° C. and a roll temperature of 120 to 180° C. (sheet molding step).

In this respect, the drying conditions of the PC resin composition (I) are preferably 130 to 140° C. and 2 to 10 hours, more preferably 130 to 140° C. and 4 to 10 hours. The above PC resin composition (I) can be dried under environment such as conventional hot air, dry air and vacuum. This drying makes it possible to remove a large part of moisture contained in the material and volatile reaction by-products produced in complexation.

A volatile removing device is required to an extruding machine for molding the sheet. This volatile removing device can allow the PC resin composition staying in a molten state to be exposed to a reduced pressure of atmospheric pressure or lower, and the pressure is reduced to −93.3 kPa (−700 mm Hg) or lower, preferably −97.3 kPa (−730 mm Hg) or lower in molding. This volatile removing at reduced pressure makes it possible to remove not only moisture remaining in the PC resin composition and volatile reaction by-products produced in complexation but also remove secondary volatile reaction by-products produced by extrusion-molding.

In this respect, if drying of the PC resin composition (I) and removing of volatile matters in extrusion-molding are unsatisfactory, foaming of the base sheet or roughening of the surface state is brought about, and the reflectance is liable to be reduced or uneven reflection is liable to be caused.

The dice temperature in molding the sheet is usually 200 to 260° C., preferably 200 to 250° C. and more preferably 200 to 240° C. If the dice temperature exceeds 260° C., a draw resonance phenomenon is liable to be caused, which results in being liable to produce the uneven thickness in a lateral direction (especially an end part) of the sheet and a longitudinal direction thereof and bring about uneven reflection on the surfaces of the sheet and the thermally molded article thereof. This is a phenomenon which is liable to be caused in molding the sheet when a large amount of titanium powder is contained in the PC resin composition (I) according to the present invention.

Further, the cooling roll temperature in molding the sheet is usually 120 to 180° C., preferably 120 to 170° C. In this case, if all roll temperatures are lower than 120° C., a molten body of the present material has a high rigidity, and sizing between nip rolls is difficult. Accordingly, homogeneity of the surface state in lateral and longitudinal directions is not maintained, and uneven reflection on the surfaces of the sheet and the thermally molded article thereof is liable to be brought about.

On the other hand, if all roll temperatures exceed 170° C., adhesion of the surface, a failure in peeling and camber of the sheet are produced by sticking and adhering onto the roll, so that the reflection plate having an even reflecting characteristic can not be obtained.

The light reflection sheet (I) of the present invention has a thermal moldability, and use of this light reflection sheet makes it possible to produce a reflection plate having reflecting surfaces corresponding to the number and the forms of light sources according to the specific thermal molding conditions. The sheet heating temperature (sheet surface temperature) in thermal molding is usually 160 to 200° C., preferably 170 to 200° C., and an average spreading magnification thereof is 1.1 to 2 times, preferably 1.2 to 1.8 time.

In the present invention, a method for thermal molding shall not specifically be restricted, and press molding, vacuum molding, vacuum pressing molding, hot plate molding and corrugation molding can be used. Also in a molding method which is usually called vacuum molding as a general term, it includes a drape forming method, a matched die method, a pressure bubble plug assist vacuum molding method, a plug assist method, a vacuum snap back method, an air slip forming method, a trapped sheet contact heating-pressure forming method and a simple press molding method. This vacuum molding is suitably carried out at a pressure of 1 MPa or less.

If the sheet heating temperature described above is lower than 160° C., thermal molding is difficult, and if it exceeds 200° C., uneven surface roughening is liable to be brought about on the surface of the sheet. If the average spreading magnification is less than 1.2 time, it is difficult to design the reflection sheet corresponding to the form of a light source. On the other hand, if it exceeds 2 times, the thermally molded article is increased in an uneven thickness, and the uneven reflectance is liable to be brought about. In the present thermal molding, the light reflection sheet is used preferably after pre-dried, and pre-drying makes it possible to prevent a foaming phenomenon caused by moisture absorption. Usually, the drying conditions are suitably 120 to 140° C. and 2 to 10 hours.

The molded article having an unevenness of 0.2 mm or less in a thickness on a light reflecting surface can be obtained by suitably controlling the sheet production conditions and the thermal molding conditions each described above. If an unevenness in the thickness on the reflecting surface exceeds 0.2 mm, the even surface reflecting characteristic is not obtained. The form of the molded article may suitably be selected corresponding to the form, the number and the characteristics of a light source. In the case of, for example, the light reflection plate for a direct under type liquid crystal back light, capable being used are forms disclosed in Japanese Patent Application Laid-Open No. 260213/2000, Japanese Patent Application Laid-Open No. 356959/2000, Japanese Patent Application Laid-Open No. 297613/2001 and Japanese Patent Application Laid-Open No. 32029/2002.

In the present invention, other layers can be laminated and provided on a sheet layer formed in the PC resin composition (I) described above according to use purposes as long as the reflecting characteristic is not damaged.

For example, a transparent polycarbonate or acryl resin layer containing an antistatic agent and a light-fast agent can be laminated on the light reflecting surface. In this case, a thickness of the resin layer is preferably 500 μm or less, and a whole light transmittance thereof per a thickness of 100 μm is preferably 85% or more.

Further, a light shading material and a layer for reinforcing the structure can be provided on a surface opposite to the light reflecting surface. In this case, the light shading material includes a metal layer of aluminum and the like having a thin thickness and a paint, and the structure reinforcing layer includes a polycarbonate base resin layer. The above other layers can be laminated by a method such as coating, vapor deposition, extrusion lamination, dry lamination and coextrusion. Further, a metal layer of an aluminum foil and the like can be provided for the purpose of diffusing heat.

The light reflection sheet (I) of the present invention can be obtained by combining the PC resin composition (I) described above with the method described above, and at lest one layer comprises the PC resin composition. The sheet has a thickness of 0.4 to 2 mm, a light reflectance of 98% or more, a light transmittance of less than 1%, a flame retardancy of a V-0 class in a thickness of 0.8 mm in a vertical flame retardant test according to a UL94 method and a thermal moldability.

In this respect, the light reflection sheet (I) has a thickness of 0.4 to 2 mm, preferably 0.6 to 2 mm and more preferably 0.6 to 1.5 mm. If a thickness of the present sheet is less than 0.4 mm, drawdown is brought about in thermally molding the reflection plate having a large area, and it is difficult to inhibit the thickness from becoming uneven, so that an unevenness in light reflection in the inside of the surface is liable to be brought about. If it exceeds 2 mm, a temperature difference between the surface on one side, the inside and the surface on the opposite side is liable to be caused in heating in thermal molding, and as a result thereof, the thermally molded article having an even reflecting characteristic is less liable to be obtained.

The light reflection sheet (I) has a light reflectance of 98% or more, preferably 98.2% or more and more preferably 98.5% or more. In this case, it can be achieved by controlling a content of titanium oxide to obtain the reflectance of such a high degree as described above.

Further, the light reflection sheet (I) has a light transmittance of less than 1%, preferably less than 0.9% and more preferably less than 0.8%. The sheet having such an excellent light shading property as described above can be achieved by a content of titanium oxide, a thickness of the sheet and a good surface condition. In this case, if the light reflectance is less than 95% or the light transmittance is 1% or more, the satisfactory luminance is less liable to be obtained in the intended reflection uses.

The light reflection sheet (I) is endowed with a flame retardancy of a V-0 class in a thickness of 0.8 mm in a vertical flame retardant test according to a UL94 method, whereby it can be enhanced in a flame retardancy as a light box.

Further, the sheet has a thermal moldability, and therefore it becomes easy to design the form thereof corresponding to the type and the number of a light source, so that a light box having a high luminance and no unevenness in the luminance can be prepared.

Next, the light reflection sheet (II) of the present invention shall be explained. The base sheet constituting the light reflection sheet (II) of the present invention comprises a polycarbonate resin composition (II) containing a combination of 85 to 60 mass % of (A) a polycarbonate base polymer and 15 to 40 mass % of (B) titanium oxide powder.

The polycarbonate base polymer (A) is preferably a mixture of (A-1) a polycarbonate-polyorganosiloxane copolymer and (A-2) a polycarbonate resin. The above component (A-1) and component (A-2) are the same as explained in the light reflection sheet (I) described above, and therefore the explanations thereof shall be omitted.

A blend proportion of the component (A-1) out of the components (A) is 5 to 85 mass parts, preferably 10 to 58 mass parts per total 100 mass parts of the respective components of (A)+(B), and a blend proportion of the component (A-2) is 0 to 80 mass parts, preferably 10 to 75 mass parts. If a blend proportion of the component (A-1) is less than 5 mass parts, polyorganosiloxane is deteriorated in dispersibility, and the satisfactory flame retardancy is not obtained. In contrast with this, if the blend proportions of the component (A-1) and the component (A-2) fall in the preferred ranges, the sheet having a good flame retardancy is obtained. A content of the polyorganosiloxane part in PC-POS may be selected according to the level of a flame retardancy required to the final resin composition. A proportion of the polyorganosiloxane part in the component (A-1) is preferably 0.3 to 10 mass %, more preferably 0.5 to 5 mass % based on the total amount of the component (A-1) and the component (A-2). In this case, if it is less than 0.3 mass %, it is likely that the satisfactory oxygen index is not obtained and that the intended flame retardancy is not revealed. On the other hand, if it exceeds 10 mass %, a heat resistance of the resin is likely to be notably reduced, which results in an increase in the cost of the resin. If it falls in the preferred range, more suitable oxygen index is obtained, and the sheet having an excellent flame retardancy is obtained. In this case, a polyorganosiloxane component contained in organosiloxane which is a component (D) described later is not included in ┌polyorganosiloxane┘ and excluded therefrom.

Titanium oxide which is the component (B) in the present invention is used in the form of fine powder for the purpose of providing the polycarbonate resin with a high reflectivity and a low transparency, that is, a high shading property. Titanium oxide which is the component (B) is the same as explained in the light reflection sheet (I) described above, and therefore the explanations thereof shall be omitted.

The PC resin composition (II) according to the present invention is preferably blended with organosiloxane as the component (D) in terms of preventing degradation of the resin and maintaining characteristics of the resin such as a mechanical strength, a stability and a heat resistance. The organosiloxane which is the component (D) is the same as explained in the light reflection sheet (I) described above, and therefore the explanations thereof shall be omitted.

The PC resin composition (II) according to the present invention can be blended, if necessary, with various inorganic fillers, additives, other synthetic resins and elastomers in addition to the respective components of (A), (B), (C) and (D) each described above as long as the objects of the present invention are not damaged. First, the inorganic fillers described above which are blended for the purposes of a rise in a mechanical strength and a durability of the PC resin composition (II) or an increase in a volume thereof include, for example, glass fibers (GF), carbon fibers, glass beads, glass flakes, carbon black, calcium sulfate, calcium carbonate, calcium silicate, alumina, silica, asbestos, talc, clay, mica and quartz powder.

The additives described above include, for example, antioxidants such as hindered phenol bases and amine bases, UV absorbers such as benzotriazole bases and benzophenone bases, external lubricants such as aliphatic carboxylic acid ester bases, paraffin bases, silicon oils and polyethylene waxes, mold releasing agents, antistatic agents and coloring matters. The other synthetic resins include respective resins such as polyethylene, polypropylene, polystyrene, AS resins (acrylonitrile-styrene copolymers), ABS resins (acrylonitrile-butadiene-styrene copolymers) and polymethyl methacrylate. The elastomers include isobutylene-isoprene rubbers, styrene-butadiene rubbers, ethylene-propylene rubbers and acryl base elastomers.

The light-fast layer constituting the light reflection sheet (II) of the present invention has a function of cutting or absorbing a UV ray. Cutting or absorbing of a UV ray can be realized by adding at least one selected from light stabilizers and UV absorbers to the light-fast layer. Suited as the light stabilizers and the UV absorbers are organic compounds such as hindered amine bases, salicylic acid bases, benzophenone bases, benzotriazole bases, benzoxazinone bases, cyanoacrylate bases, triazine bases, benzoate bases, oxalic acid anilide bases and organic nickel bases and inorganic compounds such as sol-gel.

The hindered amine base compounds include bis(2,2,6,6-tetramethyl-4-piperidyl)sebacate, dimethyl succinate-1-(2-hydroxyethyl)-4-hydroxy-2,2,6,6-tetramethylpiperidine polycondensation products, tetrakis(2,2,6,6-tetramethyl-4-piperidyl)-1,2,3,4-butanetetracarboxylate, 2,2,6,6-tetramethyl-4-piperizyl benzoate, bis(1,2,2,6,6-pentamethyl-4-piperidyl)-2-(3,5-di-t-butyl-4-hydroxybenzyl)-2-n-butyl malonate, bis(N-methyl-2,2,6,6-tetramethyl-4-piperidyl)sebacate and 1,1′-(1,2-ethanediyl)bis(3,3,5,5-tetramethylpiperazinone).

The salicylic acid base compounds include p-t-butylphenyl salicylate and p-octylphenyl salicylate.

The benzophenone base compounds include 2-hydroxy-4-n-octoxybenzophenone, 2-hydroxy-4-methoxybenzophenone, 2-hydroxy-4-ethoxybenzophenone, 2,4-dihydroxybenzophenone, 2-hydroxy-4-methoxy-5-sulfobenzophenone, 2,2′,4,4′-tetrahydroxybenzophenone, 2,2′-dihydroxy-4-methoxybenzophenone, 2,2′-dihydroxy-4,4′-dimethoxybenzophenone and bis(2-methoxy-4-hydroxy-5-benzoylphenyl)methane.

The benzotriazole base compounds include 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-5′-t-octylphenyl)benzotriazole, 2-(2′-hydroxy-3′,5′-di-t-amylphenyl)benzotriazole, 2,2′-methylenebis[4-(1,1,3,3-tetramethylbutyl)-6-(2H-benzotriazole-2-yl)phenol], 2-(2′-hydroxy-5′-methacryloxyphenyl)-2H-benzotriazole, 2-[2′-hydroxy-3′-(3″,4″,5″,6″-tetrahydrophthalimidemethyl)-5′-methylphenyl)benzotriazole, 2-(2′-hydroxy-5-acryloyloxyethylphenyl)-2H-benzotriazole, 2-(2′-hydroxy-5′-methacryloxyethylphenyl)-2H-benzotriazole and 2-(2′-hydroxy-3′-t-butyl-5′-acryloylethylphenyl)-5-chloro-2H-benzotriazole.

The cyanoacrylate base compounds include 2-ethyl-2-cyano-3,3-diphenyl acrylate, 2-ethylhexyl-2-cyano-3,3-diphenyl acrylate and 1,3-bis[2′-cyano-3,3-diphenylacryloyloxy]-2,2-bis-[(2-cyano-3′,3′-diphenylacryloyl)oxy]methylpropane.

The triazine base compounds include 2-(4,6-diphenyl-1,3,5-triazine-2-yl)-5-(hexyl)oxy-phenol and 2-(4,6-bis-2,4-dimethylphenyl-1,3,5-triazine-2-yl)-5-(hexyl)oxy-phenol.

The benzoate base compounds include 2,4-di-t-butylphenyl-3′,5′-di-t-butylphenyl-4′-hydroxybenzoate, resorcinol•monobenzoate and methyl orthobenzoylbenzoate, and the oxalic acid anilide base compounds include 2-ethoxy-2′-ethyloxalic acid bisanilide. The organic nickel base compounds include nickel bis(octylphenyl)sulfide, [2,2′-thiobis(4-t-octylphenolate)]-n-butylamine nickel, nickel complex-3,5-di-t-butyl-4-hydroxybenzyl-phosphoric acid monoethylate and nickel dibutyldithiocarbamate.

The benzoxazinone base compounds include 2,2′-(1,4-phenylene)bis[4H-3,1-benzoxazine-4-one].

The malonic acid ester base compounds include [(4-methoxyphenyl)-methylene]-dimethyl propanedioate.

Among them, the hindered amine base compounds, the benzophenone base compounds and the benzotriazole base compounds are preferred.

In the present invention, other resin components are preferably used suitably in a mixture with the light stabilizer and/or the UV absorber in order to make it easier to form the light-fast layer containing the light stabilizer and/or the UV absorber. That is, preferably used as a coating liquid are a mixed solution prepared by dissolving the resin component and the light stabilizer and/or the UV absorber in a solvent, a liquid prepared by dissolving the resin component and one of the light stabilizer and/or the UV absorber in a solvent and dispersing the other and a mixed liquid prepared by separately dissolving or dispersing in advance the resin component and the light stabilizer and/or the UV absorber in a solvent and mixing them. In this case, at least one selected from water and organic solvents may suitably be used as the solvent. Further, a copolymer of the light stabilizer component and/or the UV absorber component with the resin component is preferably used as the coating liquid as it is.

The resin component mixed or copolymerized with the light stabilizer and/or the UV absorber shall not specifically be restricted, and it includes, for example, polyester base resins, polyurethane base resins, acryl base resins, methacryl base resins, polyamide base resins, polyethylene base resins, polypropylene base resins, polyvinyl chloride base resins, polyvinylidene chloride base resins, polystyrene base resins, polyvinyl acetate base resins and fluorine base resins. The above resins can be used alone or in combination of two or more kinds thereof. In the present invention, the acryl base resins and the methacryl base resins out of the resin components described above are preferred.

In the present invention, an acryl base resin or a methacryl base resin obtained by copolymerizing the light stabilizer component and/or the UV absorber component is preferably used for the light-fast layer. When copolymerizing, a polymerizable light stabilizer component and/or a polymerizable UV absorber component is preferably copolymerized with an acryl monomer component or a methacryl monomer component.

At lest one selected from hindered amine base, benzotriazole base, benzophenone base, benzoxazinone base, cyanoacrylate base, triazine base and malonic acid ester base compounds is preferably used as the polymerizable light stabilizer component and the polymerizable UV absorber component. The above polymerizable light stabilizers and polymerizable UV absorbers may be compounds having hindered amine, benzotriazole, benzophenone, benzoxazinone, cyanoacrylate, triazine or malonic acid ester for a fundamental skeleton and having polymerizable unsaturated bonds. Usually, they are acryl base and methacryl base monomer compounds having functional groups which have a light absorbing ability and a UV ray absorbing ability at side chains and which are derived from the above compounds.

The polymerizable hindered amine base compounds include bis(2,2,6,6-tetramethyl-4-piperidyl-5-acryloyloxyethylphenyl)sebacate, dimethyl succinate.1-(2-hydroxyethyl)-4-hydroxy-2,2,6,6 -tetramethyl-5-acryloyloxyethylphenylpiperidine polycondensation products, bis(2,2,6,6-tetramethyl-4-piperidyl-5-methacryloxyethylphenyl)sebacate, dimethyl succinate.1-(2-hydroxyethyl)-4-hydroxy-2,2,6,6-tetramethyl-5-methacryloxyethylphenylpiperidine polycondensation products, bis(2,2,6,6-tetramethyl-4-piperidyl-5-acryloylethylphenyl)sebacate and dimethyl succinate.1-(2-hydroxyethyl)-4-hydroxy-2,2,6,6-tetramethyl-5-acryloylethylphenylpiperidine polycondensation products.

The polymerizable benzotriazole base compounds include 2-(2′-hydroxy-5-acryloyloxyethylphenyl)-2H-benzotriazole, 2-(2′-hydroxy-5′-methacryloxyethylphenyl)-2H-benzotriazole and 2-(2′-hydroxy-3′-t-butyl-5′-acryloylethylphenyl)-5-chloro-2H-benzotriazole.

The polymerizable benzophenone base compounds include 2-hydroxy-4-methoxy-5-acryloyloxyethylphenylbenzophenone, 2,2′-4,4′-tetrahydroxy-5-acryloyloxyethylphenylbenzophenone, 2,2′-dihydroxy-4-methoxy-5-acryloyloxyethylphenylbenzophenone, 2,2′-dihydroxy-4,4′-dimethoxy-5-acryloyloxyethylphenylbenzophenone, 2-hydroxy-4-methoxy-5-methacryloxyethylphenylbenzophenone, 2,2′-4,4′-tetrahydroxy-5-methacryloxyethylphenylbenzophenone, 2,2′-dihydroxy-4-methoxy-5-acryloylethylphenylbenzophenone and 2,2′-dihydroxy-4,4′-dimethoxy-5-acryloylethylphenylbenzophenone.

The acryl monomer components and the methacryl monomer components or the oligomer components thereof which are copolymerized with the above polymerizable light stabilizer components and/or polymerizable UV absorber components include alkyl acrylates, alkyl methacrylates (the alkyl group includes methyl, ethyl, n-propyl, isopropyl, n-butyl, isobutyl, t-butyl, 2-ethylhexyl, lauryl, stearyl and cyclohexyl) and monomers having cross-linkable functional groups (for example, monomers having a carboxyl group, a methylol group, an acid anhydride group, a sulfonic acid group, an amide group, a methyloled amide group, an amino group, an alkyloled amino group, a hydroxyl group and an epoxy group). Further, they may be copolymers with acrylonitrile, methacrylonitrile, styrene, butyl vinyl ether, maleic acid, itaconic acid and dialkyl esters thereof, methyl vinyl ketone, vinyl chloride, vinylidene chloride, vinyl acetate, vinylpyridine, vinylpyrrolidone, alkoxysilanes having a vinyl group and unsaturated polyesters.

A copolymerizing proportion of the above polymerizable light stabilizers and/or polymerizable UV absorbers to the monomers copolymerized therewith shall not specifically be restricted, and a proportion of the above polymerizable light stabilizers and/or polymerizable UV absorbers is preferably 10 mass % or more, more preferably 20 mass % or more and further preferably 35 mass % or more. Polymers obtained by polymerizing the polymerizable light stabilizers and/or the polymerizable UV absorbers without using the monomers described above may be used. A molecular weight of these polymers shall not specifically be restricted and is usually 5,000 or more, preferably 10,000 or more in terms of a toughness of the coating layer and more preferably 20,000 or more. These polymers are used in the state that they are dissolved or dispersed in an organic solvent, water or an organic solvent/water mixed solution. In addition to the copolymers described above, commercially available hybrid base light stabilized polymers can be used as well. Further, capable of being used are ┌U Double┘ manufactured by Nippon Shokubai Co., Ltd. containing a copolymer of an acryl monomer, a light absorber and a UV absorber as an effective ingredient and ┌HC-935UE┘ manufactured by Ippousha Oil Industries Co., Ltd. containing a copolymer of an aryl monomer and a UV absorber as an effective ingredient.

In the present invention, additives such as a fluorescent whitening agent and an antistatic agent can be added as long as a reflecting characteristic and a light fastness of the light-fast layer are not damaged. Capable of being used as the fluorescent whitening agent are commercial products such as Ubitec (brand name: manufactured by Ciba Specialty Chemicals Co., Ltd.), OB-1 (brand name: manufactured by Eastman Co., Ltd.), TBO (brand name: manufactured by Sumitomo Seika Chemicals Co., Ltd.), Kaycol (brand name: manufactured by Nippon Soda Co., Ltd.), Kayalite (brand name: manufactured by Nippon Kayaku Co., Ltd.) and Ryukopua EGM (brand name: manufactured by Client Japan Co., Ltd.). A content of the fluorescent whitening agent in the light-fast layer is preferably 0.01 to 2 mass %, more preferably 0.03 to 1.5 mass % and further preferably 0.05 to 1 mass %. If it is less than 0.01 mass %, the effect thereof is small. On the other hand, if it exceeds 2 mass %, the product is yellowish or likely to be readily reduced in a durability. Sulfonic acid phosphonium salts can be used as the antistatic agent.

The base sheet constituting the light reflection sheet (II) of the present invention is molded by the same method as the method explained in molding the light reflection sheet (I) described above.

The light-fast layer containing the light stabilizer and/or the UV absorber described above may be provided directly on the base sheet described above, and when the adhesive property is short, the light-fast layer is preferably provided after the surface of the base sheet is subjected to corona discharge treatment or undercoating treatment. The undercoating treatment may be carried out by a method in which an undercoating layer is provided in the sheet production step described above (inline coating method) or a method in which it is separately coated and provided after producing the base sheet (offline coating method). A material used for the undercoating treatment shall not specifically be restricted and may suitably be selected, and suited are copolymerized polyester resins, polyurethane resins, acryl resins, methacryl resins and various coupling agents.

When providing the light-fast layer on the base sheet, the coating liquid can be coated by an optional method. Capable of being used are, for example, methods such as gravure coating, roll coating, spin coating, reverse coating, bar coating, screen coating, blade coating, air knife coating and dipping. After coated, the layer is dried usually at 80 to 120° C. in a hot air oven. When the light-fast layer is cured by a publicly known method after coated, publicly known methods can be adopted therefor. Capable of being applied are, for example, a method in which it is thermally cured, a method in which it is cured by using active rays such as a UV ray, an electron beam and a radiation and a curing method carried out by combining them. In this case, a curing agent such as a cross-linking agent is preferably used in combination. The coating liquid for forming the light-fast layer may be coated in producing the base sheet (inline coating) or may be coated on the base sheet after finishing crystal alignment (offline coating).

In the light reflection sheet (II) of the present invention which is obtained in the manner described above, the light-fast layer which cuts or absorbs a UV ray (particularly a ray of 380 nm or less) is provided on at least one face of the base sheet. A thickness of the base sheet is required to be 0.4 to 2 mm, preferably 0.6 to 2 mm and more preferably 0.6 to 1.5 mm. If a thickness of the base sheet is less than 0.4 mm, drawdown is brought about in thermally molding the reflection plate having a large area, and therefore it is difficult to inhibit the thickness from becoming uneven, so that an unevenness in light reflection in the inside of the surface is liable to be brought about. On the other hand, if a thickness of the base sheet exceeds 2 mm, a temperature difference between one surface of the base sheet, the inside of the base sheet and the other surface of the base sheet is liable to be caused, and as a result thereof, the thermally molded article having an even reflecting characteristic is less liable to be obtained.

A thickness of the light-fast layer is required to be 0.5 to 20 μm, preferably 1 to 15 μm and more preferably 2 to 10 μm. If a thickness of the light-fast layer is less than 0.5 μm, a UV ray cutting performance and a UV ray absorbing performance in the light-fast layer are unsatisfactory, and if a thickness of the light-fast layer exceeds 20 μm, a high reflecting characteristic of the light reflection sheet (II) is inhibited.

In the light reflection sheet (II) of the present invention, a reflectance measured by irradiating the surface of the light-fast layer with light of a visible light region wavelength is preferably 90% or more, more preferably 95% or more and further preferably 97% or more. The reflectance of such a high degree as described above can be achieved by controlling a content of titanium oxide in the PC resin composition (II) constituting the base sheet. Further, the light reflection sheet (II) has a light transmittance of preferably less than 1%, more preferably less than 0.9% and further preferably less than 0.8%. The sheet having such an excellent light shading property as described above can be achieved by a content of titanium oxide, a thickness of the sheet and a good surface condition.

If the light reflectance described above is less than 90% or the light transmittance is 1% or more, the satisfactory luminance is less liable to be obtained in the intended reflection uses. Further, the sheet has a thermal moldability, and therefore it becomes easy to design the form thereof corresponding to the type and the number of a light source, so that a light box having a high luminance and no unevenness in the luminance can be prepared.

In the light reflection sheet (II) of the present invention, it is preferred in terms of inhibiting a change in a color tone of the liquid crystal image plane and a reduction in a luminance thereof when using the liquid crystal image plane over a long period of time that a color difference (ΔE) between before and after irradiation which is observed when irradiating the surface of the light-fast layer with a UV ray in an energy amount of 20 J/cm² by means of a high pressure mercury lamp is 10 or less and that a reduction in a reflectance of visible light is 5% or less. More preferably, the color difference (ΔE) between before and after irradiation is 5 or less, and a reduction in a reflectance of visible light is 3% or less.

The light reflection sheet (II) of the present invention has a thermal moldability, and use of this light reflection sheet makes it possible to produce a reflection plate having a reflecting surface corresponding to the type and the number of a light source according to a specific thermal molding condition. This thermal molding condition is the same as the thermal molding condition in the light reflection sheet (I) described above excluding the drying conditions in pre-drying, and therefore the explanations thereof shall be omitted. In the light reflection sheet (II), usually the drying conditions described above are suitably 100 to 120° C. and 5 to 12 hours.

A molded article having a thickness unevenness of 0.2 mm or less on a light reflecting surface can be obtained by suitably controlling the sheet production conditions and the thermal molding conditions each described above. If a thickness unevenness on the light reflecting surface exceeds 0.2 mm, the even surface reflecting characteristic is not obtained. The form of the molded article can be the same as the form explained in the light reflection sheet (I) described above.

The light reflection sheet (II) of the present invention is a light reflection sheet which is less yellowed and less reduced in a reflecting characteristic even after used over a long period of time and which can be thermally molded in the same manner as in a single layer sheet comprising a PC resin composition.

Next, the light reflection sheet (III) of the present invention shall be explained. The base sheet constituting the light reflection sheet (III) of the present invention comprises a PC resin composition (III) containing a combination of 85 to 60 mass % of (A) a polycarbonate base polymer and 15 to 40 mass % of (B) titanium oxide.

The polycarbonate base polymer (A) includes a mixture of (A-0) a polycarbonate resin or (A-1) a polycarbonate-polyorganosiloxane copolymer and (A-2) a polycarbonate resin. The above component (A-1) and component (A-2) are the same as explained in the light reflection sheet (I) described above, and the component (A-0) is the same as the component (A-2). Accordingly, the explanations thereof shall be omitted.

A blend proportion of the component (A-1), a blend proportion of the component (A-2) out of the components (A) per total 100 mass parts of the respective components of (A)+(B) and the components (B), (C) and (D) are the same as explained in the light reflection sheet (II) described above, and therefore the explanations thereof shall be omitted.

The PC resin composition (III) according to the present invention can be blended, if necessary, with various inorganic fillers, additives, other synthetic resins and elastomers in addition to the respective components of (A), (B), (C) and (D) each described above as long as the objects of the present invention are not damaged. They are the same as explained in the light reflection sheet (II) described above, and therefore the explanations thereof shall be omitted.

The light diffusion layer constituting the light reflection sheet (III) has a function of diffusing and reflecting light. Diffusion and reflection of light can be realized by dispersing particles which are selected from organic particles and inorganic particles and which have an average particle diameter of 1 to 20 μm, preferably 1 to 15 μm and more preferably 3 to 15 μm in the light diffusion layer. If the above average particle diameter is less than 1 μm, the effect of diffusing and reflecting light is unsatisfactory. On the other hand, if the average particle diameter exceeds 20 μm, the surface is liable to be roughened more than necessary, and the particles are liable to fall out.

The organic particles include acryl base cross-linked particles, styrene base cross-linked particles and the like, and the acryl base cross-linked particles and the styrene base cross-linked particles are preferred. Commercial products of the acryl base cross-linked particles include MBX (brand name: manufactured by Sekisui Plastics Co., Ltd.). The inorganic particles include silica, titanium oxide, alumina, zinc oxide, barium sulfate, calcium carbonate, zeolite, kaoline and talc, and silica and titanium oxide are preferred. Commercial products of silica include Mizukasil (brand name: manufactured by Mizusawa Industrial Chemicals, Ltd.). The above particles may be used alone or in a mixture of two or more kinds thereof.

A content of the above particles is preferably 0.5 to 50 mass %, more preferably 5 to 20 mass % based on the light diffusion layer in terms of a diffusion reflectivity of light.

In the present invention, the organic particles and/or the inorganic particles are preferably used after dispersed in the resin component in order to make it easy to form the light diffusion layer containing the organic particles and/or the inorganic particles. That is, preferably used as a coating liquid are a liquid prepared by dissolving the resin component and dispersing the organic particles and/or the resin component and the inorganic particles and a mixed liquid prepared by separately dissolving or dispersing in advance the organic particles and/or the inorganic particles in a solvent and mixing them. In this case, at least one selected from water and organic solvents may suitably be used as the solvent.

The resin component mixed with the organic particles and/or the inorganic particles shall not specifically be restricted, and it includes, for example, polyester base resins, polyurethane base resins, acryl base resins, methacryl base resins, polyamide base resins, polyethylene base resins, polypropylene base resins, polyvinyl chloride base resins, polyvinylidene chloride base resins, polystyrene base resins, polyvinyl acetate base resins and fluorine base resins. The above resin can be used alone or in combination of two or more kinds thereof. In the present invention, the acryl base resins and the methacryl base resins out of the resin components described above are preferred.

In the present invention, an acryl base resin or a methacryl base resin obtained by copolymerizing the light stabilizer component and/or the UV absorber component is preferably used for the light-fast layer. When copolymerizing, the light stabilizer component and/or the UV absorber component is preferably copolymerized with an acryl monomer component or a methacryl monomer component.

In the present invention, at least one selected from the light stabilizer and the UV absorber is preferably added to the light diffusion layer in terms of providing the light reflection sheet (III) with a cutting or absorbing performance of a UV ray. Suited as the light stabilizer and the UV absorber are organic compounds such as hindered amine bases, salicylic acid bases, benzophenone bases, benzotriazole bases, benzoxazinone bases, cyanoacrylate bases, triazine bases, benzoate bases, oxalic acid anilide bases and organic nickel bases and inorganic compounds such as sol-gel. The specific examples thereof are the same as explained in the light reflection sheet (II) described above, and therefore the explanations thereof shall be omitted.

In the present invention, other resin components are preferably used in a mixture with the light stabilizer and/or the UV absorber in order to make it easier to form the light diffusion layer containing the light stabilizer and/or the UV absorber. That is, preferably used as a coating liquid are a mixed solution prepared by dissolving the resin component and the light stabilizer and/or the UV absorber in a solvent, a liquid prepared by dissolving the resin component and one of the light stabilizer and/or the UV absorber in a solvent and dispersing the other and a mixed liquid prepared by separately dissolving or dispersing in advance the resin component and the light stabilizer and/or the UV absorber in a solvent and mixing them. In this case, at least one selected from water and organic solvents may suitably be used as the solvent. Further, a copolymer of the light stabilizer component and/or the UV absorber component with the resin component is preferably used for the coating liquid as it is.

In the present invention, a polymerizable light stabilizer component and/or UV absorber component is preferably copolymerized with an acryl monomer component or a methacryl monomer component.

At lest one selected from hindered amine base, benzotriazole base, benzophenone base, benzoxazinone base, cyanoacrylate base, triazine base and malonic acid ester base compounds is preferably used as the polymerizable light stabilizer component and UV absorber component. They are the same as explained in the light reflection sheet (II) described above, and therefore the explanations thereof shall be omitted.

In the present invention, additives such as fluorescent whitening agents and antistatic agents can be added as long as a reflecting characteristic and a light fastness of the light diffusion layer are not damaged. They are the same as explained in the light reflection sheet (II) described above, and therefore the explanations thereof shall be omitted.

The base sheet constituting the light reflection sheet (III) of the present invention is molded by the same method as explained in molding the light reflection sheet (I) described above.

The light diffusion layer containing the organic particles and/or the inorganic particles described above may be provided directly on the base sheet described above, and when the adhesive property is short, the light diffusion layer is preferably provided after the surface of the base sheet is subjected to corona discharge treatment or undercoating treatment. The above undercoating treatment and a coating method of the coating liquid when providing the light diffusion layer on the base sheet are the same as in providing the light-fast layer in the light reflection sheet (II) described above, and therefore the explanations thereof shall be omitted.

In the light reflection sheet of the present invention which is obtained in the manner described above, the light diffusion layer which diffuses and reflects light is provided on at least one face of the base sheet. A thickness of the base sheet is required to be 0.4 to 2 mm, preferably 0.6 to 2 mm and more preferably 0.6 to 1.5 mm. If a thickness of the base sheet is less than 0.4 mm, drawdown is brought about in thermally molding the reflection plate having a large area, and therefore it is difficult to inhibit the thickness from becoming uneven, so that an unevenness in light reflection in the inside of the surface is liable to be brought about. On the other hand, if a thickness of the base sheet exceeds 2 mm, a temperature difference between one surface of the base sheet, the inside of the base sheet and the other surface of the base sheet is liable to be caused, and as a result thereof, the thermally molded article having an even reflecting characteristic is less liable to be obtained.

A thickness of the light diffusion layer is required to be 0.5 to 20 μm, preferably 1 to 15 μm and more preferably 2 to 10 μm. If a thickness of the light diffusion layer is less than 0.5 μm, a diffusing and reflecting performance of light in the light diffusion layer is unsatisfactory, and if a thickness of the light diffusion layer exceeds 20 μm, a high reflecting characteristic of the light reflection sheet is inhibited.

In the light reflection sheet (III) of the present invention, a reflectance measured by irradiating the surface of the light diffusion layer with light of a visible light region wavelength is preferably 90% or more, more preferably 95% or more and further preferably 97% or more. The reflectance of such a high degree as described above can be achieved by controlling a content of titanium oxide in the PC resin composition forming the base sheet. Further, the light reflection sheet has a light transmittance of preferably less than 1%, more preferably less than 0.9% and further preferably less than 0.8%. The sheet having such an excellent light shading property as described above can be achieved by a content of titanium oxide, a thickness of the sheet and a good surface condition.

If the light reflectance described above is less than 90% or the light transmittance is 1% or more, the satisfactory luminance is less liable to be obtained in the intended reflection uses. Further, the sheet has a thermal moldability, and therefore it becomes easy to design the form thereof corresponding to the type and the number of a light source, so that a light box having a high luminance and no unevenness in the luminance can be prepared.

In the light reflection sheet (III) of the present invention, it is preferred in terms of inhibiting an unevenness (due to the position of a fluorescent tube in an inside) in a luminance of the liquid crystal image plane that a difference between a total reflectance (SCI) measured by irradiating the surface of the light diffusion layer with light of a visible light region wavelength and a reflectance (SCE) obtained by deducting specular reflection from total reflectance is 4% or less.

In the light reflection sheet (III) of the present invention, it is preferred in terms of inhibiting a change in a color tone of the liquid crystal image plane and a reduction in a luminance thereof that a color difference (ΔE) between before and after irradiation which is observed when irradiating the surface of the light diffusion layer with a UV ray in an energy amount of 20 J/cm² by means of a high pressure mercury lamp is 10 or less and that a reduction in a reflectance of visible light is 5% or less. More preferably, the color difference (ΔE) between before and after irradiation is 5 or less, and a reduction in a reflectance of visible light is 3% or less.

The light reflection sheet (III) of the present invention has a thermal moldability, and use of this light reflection sheet makes it possible to produce a reflection plate having a reflecting surface corresponding to the number and the form of a light source according to a specific thermal molding condition. This thermal molding condition is the same as the thermal molding condition in the light reflection sheet (I) described above excluding the drying conditions in pre-drying, and therefore the explanations thereof shall be omitted. In the light reflection sheet (III), usually the drying conditions described above are suitably 100 to 120° C. and 5 to 12 hours.

A molded article having a thickness unevenness of 0.2 mm or less on a light reflecting surface can be obtained by suitably controlling the sheet production conditions and the thermal molding conditions each described above. If a thickness unevenness on the light reflecting surface exceeds 0.2 mm, the even surface reflecting characteristic is not obtained. The form of the molded article can be the same as the form explained in the light reflection sheet (I) described above.

The light reflection sheet (III) of the present invention is improved in a light diffusing and reflecting property and makes it possible to form a liquid crystal image plane having less luminance unevenness when it is used as a direct under type liquid crystal back light, and it is a light reflection sheet which can be thermally molded in the same manner as in a single layer sheet comprising a PC resin composition.

### EXAMPLES

Next, the present invention shall be explained in further details with reference to examples and comparative examples, but the present invention shall by no means be restricted by these examples.

### Production Example 1

### Production of PC-PDMS Copolymer

(1) Production of PC Oligomer

Bisphenol A of 60 kg was dissolved in a 5 mass % sodium hydroxide aqueous solution of 400 liter to prepare a sodium hydroxide aqueous solution of bisphenol A. Then, a tubular reactor having an inner diameter of 10 mm and a tube length of 10 m was charged with the above sodium hydroxide aqueous solution of bisphenol A maintained at room temperature at a flow amount of 138 liter/hour and methylene chloride at a flow amount of 69 liter/hour through an orifice plate, and phosgene was blown thereinto in a parallel flow at a flow amount of 10.7 kg/hour to continuously react them for 3 hours. The tubular reactor used above assumed a double tube structure, and cooling water was passed through the jacket part to maintain a discharge temperature of the reaction liquid at 25° C. The discharge liquid was controlled to a pH of 10 to 11.

The reaction liquid thus obtained was left standing still, whereby the aqueous phase was separated and removed, and the methylene chloride phase (220 liter) was recovered to obtain a PC oligomer (concentration: 317 g/liter). The PC oligomer obtained above had a polymerization degree of 2 to 4, and the chloroformate group had a concentration of 0.7 normal.

(2) Production of Reactive PDMS

Mixed were 1,483 g of octamethylcyclotetrasiloxane, 96 g of 1,1,3,3-tetramethyldisiloxane and 35 g of 86% sulfuric acid, and the mixture was stirred at room temperature for 17 hours. Then, the oil phase was separated and blended with 25 g of sodium hydrogencarbonate, and the mixture was stirred for one hour. After filtering, the filtrate was distilled under vacuum at 150° C. and 3 torr (400 Pa) to remove low boiling matters, whereby an oil was obtained.

The oil 294 g obtained above was added to a mixture of 60 g of 2-allylphenol and platinum in the form of 0.0014 g of a platinum chloride-alcolate complex at a temperature of 90° C. This mixture was stirred for 3 hours while maintaining at a temperature of 90 to 115° C. The reaction product was extracted with methylene chloride and washed three times with aqueous methanol of 80% to remove excessive 2-allylphenol. The product thus obtained was dried on anhydrous sodium sulfate, and the solvent was distilled off in vacuum at a temperature of up to 115° C. In reactive PDMS (polydimethylsiloxane) thus obtained having phenol at an end, a repeating number of a dimethylsilanoxy unit measured by NMR was 30.

(3) Production of PC-PDMS Copolymer

Reactive PDMS 138 g obtained in (2) described above was dissolved in 2 liter of methylene chloride, and the solution was mixed with 10 liter of the PC oligomer obtained in (1). A solution prepared by dissolving 26 g of sodium hydroxide in one liter of water and 5.7 ml of triethylamine were added thereto to react them at room temperature for one hour while stirring at 500 rpm.

After finishing the reaction, a solution obtained by dissolving 600 g of bisphenol A in 5 liter of a sodium hydroxide aqueous solution of 5.2 mass %, 8 liter of methylene chloride and 96 g of t-butylphenol were added to the reaction system described above to react them at room temperature for 2 hours while stirring at 500 rpm.

After finishing the reaction, 5 liter of methylene chloride was added thereto, and the mixture was washed in order with 5 liter of water, 5 liter of a 0.03 normal sodium hydroxide aqueous solution, 5 liter of 0.2 normal hydrochloric acid and twice with 5 liter of water, and finally methylene chloride was removed to obtain a flaky PC-PDMS copolymer. The PC-PDMS copolymer thus obtained was dried under vacuum at 120° C. for 24 hours. The viscosity average molecular weight was 17,000, and the PDMS content was 3.0 mass %. The viscosity average molecular weight (Mv) and the PDMS content were determined by the following methods.

(1) Viscosity Average Molecular Weight (Mv)

A viscosity of the methylene chloride solution at 20° C. was measured by means of a Ubbelohde viscometer, and the limiting viscosity [η] was determined from the above value to calculate the viscosity average molecular weight according to the following equation:
[72]=1.23×10⁻⁵ Mv^{0.83}
(2) PDMS Content

It was determined based on an intensity ratio of a peak of a methyl group in isopropyl of bisphenol A which was observed in 1.7 ppm by ¹H-NMR to a peak of a methyl group in dimethylsiloxane which was observed in 0.2 ppm.

### Production Example 2

### Production of PC Resin Composition-1

Total 100 mass parts of 46 mass % of the polycarbonate-polydimethylsiloxane copolymer (PC-PDMS, Mv=17,000, PDMS content=3.0 mass %) obtained in Production Example 1, 24 mass % of bisphenol A type linear polycarbonate 1 (brand name: Tarflon FN1500, Mv=14,500, manufactured by Idemitsu Petrochemical Co., Ltd.) and 30 mass % of titanium oxide powder (brand name: PF726, manufactured by Ishiwara Sangyo Co., Ltd.) was mixed with 1.2 mass part of organosiloxane (brand name: BY16-161, manufactured by•Dow Corning Toray Co., Ltd.), 0.3 mass part of polytetrafluoroethylene (PTFE, brand name: CD076, manufactured by Asahi Glass Co., Ltd.) and 0.1 mass part of triphenylphosphine (brand name: JC263, manufactured by Johoku Chemical Co., Ltd.), and the mixture was molten and kneaded by means of a double shaft extruding machine to obtain a PC resin composition-1.

### Production Example 3

### Production of PC Resin Composition-2

Total 100 mass parts of 40 mass % of bisphenol A type linear polycarbonate 2 (brand name: Tarflon FN1900, Mv=19,000, manufactured by Idemitsu Petrochemical Co., Ltd.), 40 mass % of bisphenol A type linear polycarbonate 3 (brand name: Tarflon FN1700, Mv=17,000, manufactured by Idemitsu Petrochemical Co., Ltd.) and 20 mass % of titanium oxide powder (brand name: PF726, manufactured by Ishiwara Sangyo Co., Ltd.) was mixed with 0.6 mass part of organosiloxane (brand name: BY16-161, manufactured by Dow Corning Toray Co., Ltd.), 2 mass parts of phosphoric acid ester (brand name: PFR, manufactured by Asahi Denka Kogyo K. K.), 0.1 mass part of triphenylphosphine (brand name: JC263, manufactured by Johoku Chemical Co., Ltd.) and 0.3 mass part of polytetrafluoroethylene (PTFE, brand name: CD076, manufactured by Asahi Glass Co., Ltd.), and the mixture was molten and kneaded by means of a double shaft extruding machine to obtain a PC resin composition-2.

### Production Example 4

### Production of PC Resin Composition-3

Total 100 mass parts of 46 mass % of the polycarbonate-polyorganosiloxane copolymer obtained in Production Example 1 (3), 29 mass % of bisphenol A type linear polycarbonate (brand name: Tarflon FN1500, Mv=14,500, manufactured by Idemitsu Petrochemical Co., Ltd.) and 25 mass % of titanium oxide powder (brand name: PF726, manufactured by Ishiwara Sangyo Co., Ltd.) was mixed with 1.0 mass part of organosiloxane (brand name: BY16-161, manufactured by Dow Corning Toray Co., Ltd.), 0.3 mass part of polytetrafluoroethylene (PTFE, brand name: CD076, manufactured by Asahi Glass Co., Ltd.) and 0.1 mass part of triphenylphosphine (brand name: JC263, manufactured by Johoku Chemical Co., Ltd.) as an antioxidant, and the mixture was molten and kneaded by means of a double shaft extruding machine to obtain a PC resin composition-3.

### Production Example 5

### Production of PC Resin Composition-4

Total 100 mass parts of 46 mass % of the polycarbonate-polyorganosiloxane copolymer obtained in Production Example 1 (3), 34 mass % of bisphenol A type linear polycarbonate (brand name: Tarflon FN1500, Mv=14,500, manufactured by Idemitsu Petrochemical Co., Ltd.) and 20 mass % of titanium oxide powder (brand name: PF726, manufactured by Ishiwara Sangyo Co., Ltd.) was mixed with 1.0 mass part of organosiloxane (brand name: BY16-161, manufactured by Dow Corning Toray Co., Ltd.), 0.3 mass part of polytetrafluoroethylene (PTFE, brand name: CD076, manufactured by Asahi Glass Co., Ltd.) and 0.1 mass part of triphenylphosphine (brand name: JC263, manufactured by Johoku Chemical Co., Ltd.) as an antioxidant, and the mixture was molten and kneaded by means of a double shaft extruding machine to obtain a PC resin composition-4.

### Production Example 6

### Production of PC Resin Composition-5

Total 100 mass parts of 90 mass % of bisphenol A type linear polycarbonate (brand name: Tarflon FN1500, Mv=14,500, manufactured by Idemitsu Petrochemical Co., Ltd.) and 10 mass % of titanium oxide powder (brand name: PF726, manufactured by Ishiwara Sangyo Co., Ltd.) was mixed with 0.3 mass part of polytetrafluoroethylene (PTFE, brand name: CD076, manufactured by Asahi Glass Co., Ltd.) and 0.1 mass part of triphenylphosphine (brand name: JC263, manufactured by Johoku Chemical Co., Ltd.) as an antioxidant, and the mixture was molten and kneaded by means of a double shaft extruding machine to obtain a PC resin composition-5.

### Production Example 7

### Production of Transparent, Light-Fast, Antistatic and Flame Retardant Polycarbonate Base Film

Mixed were 46 mass % of the polycarbonate-polyorganosiloxane copolymer obtained in Production Example 1 (3), 52.7 mass % of bisphenol A type polycarbonate (brand name: Tarflon A2600, Mv=26,000, manufactured by Idemitsu Petrochemical Co., Ltd.), 1 mass % of alkylbenzenesulfonic acid phosphonium salt (ISP101, manufactured by Takemoto Oil & Fat Co., Ltd.) and 0.3 mass % of ChemiSorb 79 (manufactured by Chemipro Kasei Kaisha, Ltd.) as a light-fast agent, and the mixture was molten and kneaded by means of a double shaft extruding machine to obtain a PC resin composition. This transparent, light-fast and antistatic composition was used to produce a film having a thickness of 50 μm by cast molding. This film had a full light transmittance of 93%.

### Production Example 8

### Production of PC Resin Composition-6

Total 100 mass parts of 46 mass % of the polycarbonate-polydimethylsiloxane copolymer (PC-PDMS, Mv=17,000, PDMS content=3.0 mass %) obtained in Production Example 1, 24 mass % of bisphenol A type linear polycarbonate 1 (brand name: Tarflon FN1500, Mv=14,500, manufactured by Idemitsu Petrochemical Co., Ltd.) and 30 mass % of titanium oxide powder (brand name: PF726, manufactured by Ishiwara Sangyo Co., Ltd.) was mixed with 1.2 mass part of organosiloxane (brand name: BY16-161, manufactured by Dow Corning Toray Co., Ltd.), 0.3 mass part of polytetrafluoroethylene (PTFE, brand name: CD076, manufactured by Asahi Glass Co., Ltd.) and 0.1 mass part of triphenylphosphine (brand name: JC263, manufactured by Johoku Chemical Co., Ltd.), and 1 mass part of a UV absorber (brand name: ChemiSorb, manufactured by Chemipro Kasei Kaisha, Ltd.) was further added thereto. The mixture thus obtained was molten and kneaded by means of a double shaft extruding machine to obtain a PC resin composition-6.

### Example 1

The PC resin composition-1 (PC-1, pellet) was dried in a hot air oven on the conditions of 140° C. and 4 hours. The dried composition was used and extruded to a horizontal direction by means of an extruding apparatus having a 65 mmφ single shaft extruder equipped with a volatile remover, a gear pump and a coat hanger die having a width of 60 cm, and it was molded into a sheet by a vertical three cooling roll system to obtain the sheet having a thickness of 1 mm.

In this case, the cylinder temperature was 250 to 260° C.; the volatile removing pressure was −100.0 kPa (−750 mm Hg); the dice temperature was 240° C.; the roll temperatures were No. 1./No. 2/No. 3=120° C./150° C./170° C.; and the extruding amount was 30 kg/hour. The physical properties of the above sheet are shown in Table 1.

### Example 2

The same procedure as in Example 1 was carried out, except that the PC resin composition-1 (PC-1, pellet) was dried in the hot air oven at 120° C. for 10 hours.

### Example 3

The same procedure as in Example 1 was carried out, except that the volatile removing pressure was changed to −101.3 kPa (−760 mm Hg).

### Example 4

The same procedure as in Example 1 was carried out, except that the dice temperature was changed to 250° C.

### Examples 5 and 6

The same procedure as in Example 1 was carried out, except that the receiving speed was controlled to obtain sheets having a thickness of 1.6 mm and a thickness of 0.6 mm.

### Example 7

The same procedure as in Example 1 was carried out, except that the PC resin composition-2 (PC-2) was used.

### Example 8

The same procedure as in Example 1 was carried out, except that the PC resin composition-3 (PC-3) was used.

### Example 9

The same procedure as in Example 1 was carried out, except that the PC resin composition-4 (PC-4) was used.

### Example 10

The transparent, light-fast, antistatic and flame retardant polycarbonate base film for sheet lamination produced in Production Example 7 was introduced between a No. 2 roll and a melting web in molding the sheet and thermally laminated by nip pressure to obtain a laminated sheet.

### Comparative Example 1

The same procedure as in Example 1 was carried out, except that the material pellets were used without drying.

### Comparative Example 2

The same procedure as in Example 1 was carried out, except that the volatile remover of the extruder was not used.

### Comparative Example 3

The same procedure as in Example 1 was carried out, except that the dice temperature was changed to 270° C.

### Comparative Example 4

The same procedure as in Example 1 was carried out, except that all the roll temperatures of No. 1 to No. 3 were changed to 110° C. Floating and warping of the sheet were caused, and a sheet capable of being evaluated could not be obtained.

### Comparative Example 5

The same procedure as in Example 1 was carried out, except that all the roll temperatures of No. 1 to No. 3 were changed to 190° C. The sheet was notably stuck to the cooling roll to make a flatness inferior, and the sheet capable of being evaluated could not be obtained.

### Comparative Example 6

The same procedure as in Example 1 was carried out, except that the PC resin composition-5 (PC-5) was used.

The respective evaluation results are shown in Table 1.

TABLE 1

| | | | Volatile | Dice | Cooling roll | Sheet | Sheet | | | | |
|---|---|---|---|---|---|---|---|---|---|---|---|
| | | | removing | temper- | temperature | average | thickness | | Reflec- | Transmit- | Flame |
| | | | pressure | ature | No. 1/No. 2/ | thickness | unevenness | Rough | tance | tance | retardancy |
| | Material | Resin drying | (kPa) | (° C.) | No. 3 (° C.) | (mm) | (±mm) | surface | (%) | (%) | V-0 |
| Example 1 | PC-1 | 140° C., 4 hr | −100.0 | 210 | 120/150/170 | 1 | 0.03 | None | 98.7 | 0.2 | Acceptance |
| Example 2 | PC-1 | 120° C., 10 hr | −100.0 | 210 | 120/150/170 | 1 | 0.03 | None | 98.6 | 0.2 | Acceptance |
| Example 3 | PC-1 | 140° C., 4 hr | −101.3 | 210 | 120/150/170 | 1 | 0.03 | None | 98.8 | 0.2 | Acceptance |
| Example 4 | PC-1 | 140° C., 4 hr | −100.0 | 250 | 120/150/170 | 1 | 0.03 | None | 98.7 | 0.2 | Acceptance |
| Example 5 | PC-1 | 140° C., 4 hr | −100.0 | 210 | 120/150/170 | 1.6 | 0.02 | None | 98.9 | 0.1 | Acceptance |
| Example 6 | PC-1 | 140° C., 4 hr | −100.0 | 210 | 120/150/170 | 0.6 | 0.04 | None | 98.0 | 0.7 | Acceptance |
| Example 7 | PC-2 | 140° C., 4 hr | −100.0 | 210 | 120/150/170 | 1 | 0.03 | None | 98.7 | 0.2 | Acceptance |
| Example 8 | PC-3 | 140° C., 4 hr | −100.0 | 210 | 120/150/170 | 1 | 0.03 | None | 98.5 | 0.3 | Acceptance |
| Example 9 | PC-4 | 140° C., 4 hr | −100.0 | 210 | 120/150/170 | 1 | 0.03 | None | 98.3 | 0.4 | Acceptance |
| Example 10 | PC-1 | 140° C., 4 hr | −100.0 | 210 | 120/150/170 | 1.1 | 0.03 | None | 98.9 | 0.2 | Acceptance |
| Comparative | PC-1 | None | −100.0 | 210 | 120/150/170 | 1 | 0.05 | Present | 97.3 | 1.2 | Acceptance |
| Example 1 | | | | | | | | | | | |
| Comparative | PC-1 | 140° C., 4 hr | Atmospheric | 210 | 120/150/170 | 1 | 0.04 | Present | 97.5 | 1.1 | Acceptance |
| Example 2 | | | pressure | | | | | | | | |
| Comparative | PC-1 | 140° C., 4 hr | −100.0 | 270 | 120/150/170 | 1 | 0.42 | Present | 98.7 | 0.3 | Acceptance |
| Example 3 | | | | | | | | | | | |
| Comparative | PC-5 | 140° C., 4 hr | −100.0 | 210 | 120/150/170 | 1 | 0.04 | None | 95.3 | 2.0 | Rejection |
| Example 6 | | | | | | | | | | | |

### Example 11

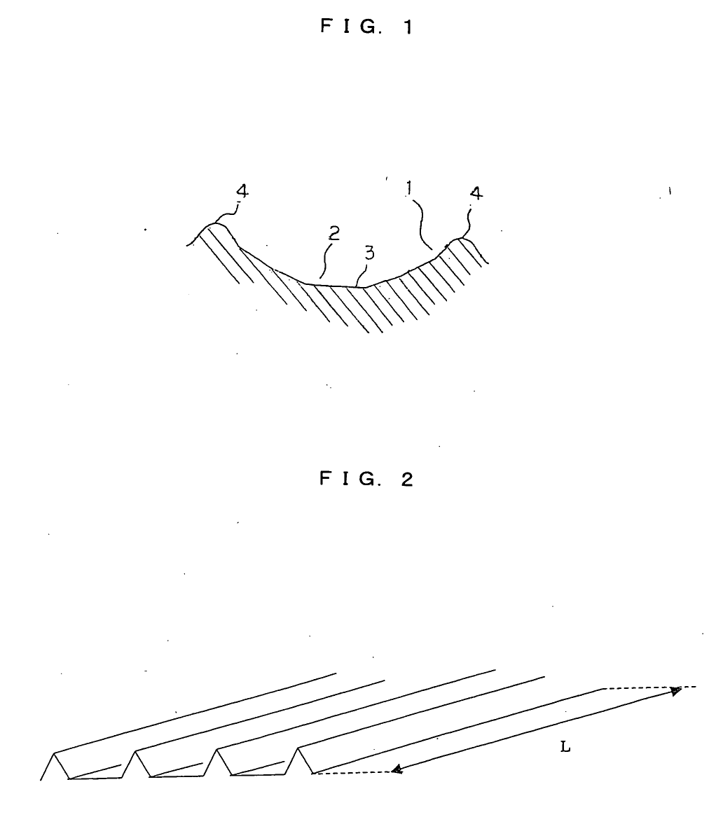

The sheet prepared in Example 1 was used, and a reflection plate molded article having a shape shown in FIG. 1 used for direct under illumination (refer to, for example, Japanese Patent Application Laid-Open No. 32029/2002) was produced by thermal molding. The sheet was dried at 140° C. for 5 hours, and the molded article was obtained by heating the surface of the sheet at a temperature of 140° C. and then vacuum-molding it by an A1 die having an average spreading magnification of 1.3 time by means of a thermal molding machine of an FK-0431-10 type manufactured by Asano Laboratories Co., Ltd.

In FIG. 1, a reflection plate 1 has curved parts 4 at both ends; a light source-receiving groove is formed in a central part; and a reflecting surface consists of a multi-curved surface 3.

### Example 12

The same procedure as in Example 11 was carried out, except that the sheet prepared in Example 5 was used and that an A1 die having an average spreading magnification of 1.8 time was used.

### Example 13

The same procedure as in Example 11 was carried out, except that the sheet prepared in Example 6 was used and that an A1 die having an average spreading magnification of 1.15 time was used.

### Comparative Example 7

The same procedure as in Example 11 was carried out, except that the sheet surface temperature in thermal molding was changed to 155° C.

### Comparative Example 8

The same procedure as in Example 11 was carried out, except that the sheet surface temperature in thermal molding was changed to 210° C.

### Comparative Example 9

The same procedure as in Example 11 was carried out, except that the sheet prepared in Example 5 was used and that an A1 die having an average spreading magnification of 2.3 times was used.

### Comparative Example 10

The same procedure as in Example 11 was carried out, except that the sheet prepared in Comparative Example 9 was used.

The physical properties of the thermally molded articles are shown in Table 2.

TABLE 2

| | | Heating | | Average | Thickness unevenness | |
|---|---|---|---|---|---|---|
| | | temperature | Average | thickness | on reflecting face | Evenness |
| | | in thermal | spreading | of thermally molded | of thermally molded | of face |
| | Sheet | molding (° C.) | magnification | article (mm) | article (±mm) | reflection |
| Example 11 | Sheet of Example 1 | 180 | 1.3 | 0.77 | 0.05 | Good |
| Example 12 | Sheet of Example 5 | 180 | 1.8 | 0.89 | 0.06 | Good |
| Example 13 | Sheet of Example 6 | 180 | 1.15 | 0.52 | 0.03 | Good |
| Comparative | Sheet of Example 1 | 155 | 1.3 | 0.77 | Difficult to | — |
| Example 7 | | | | | be molded | |
| Comparative | Sheet of Example 1 | 210 | 1.3 | 0.77 | 0.25 | Inferior |
| Example 8 | | | | | (rough surface) | |
| Comparative | Sheet of Example 5 | 180 | 2.3 | 0.70 | 0.30 | Inferior |
| Example 9 | | | | | (rough surface) | |
| Comparative | Sheet of Comparative | 180 | 1.3 | 0.77 | 0.25 | Inferior |
| Example 10 | Example 3 | | | | | |

### Example 14

The PC resin composition-1 (PC-1, pellet) was dried in a hot air oven on the conditions of 140° C. and 4 hours. The dried composition was used and extruded to a horizontal direction by means of an extruding apparatus having a 65 mmφ single shaft extruder equipped with a volatile remover, a gear pump and a coat hanger die having a width of 60 cm, and it was molded into a sheet by a vertical three cooling roll system to obtain the sheet having a thickness of 600 μm. In this regard, the cylinder temperature was 250 to 260° C.; the volatile removing pressure was −100.0 kPa (−750 mm Hg); the dice temperature was 210° C.; the roll temperatures were No. 1./No. 2/No. 3=120° C./150° C./170° C.; and the extruding amount was 30 kg/hour.

A coating liquid prepared by diluting a light stabilizer (brand name: U Double UV-G12, manufactured by Nippon Shokubai Co., Ltd.) in a concentration of 20 mass % in terms of a solid content by diacetone alcohol was coated on one surface of the sheet described above to a thickness of 5 μm by means of a bar coater, and it was dried in a hot air oven on the conditions of 120° C. and 5 minutes to form a light-fast layer, whereby a light reflection sheet was prepared.

### Example 15

A light reflection sheet was prepared in the same manner as in Example 14, except that in Example 14, a thickness of the light-fast layer was changed to 10 μm.

### Example 16

A light reflection sheet was prepared in the same manner as in Example 14, except that in Example 14, the PC resin composition-2 (PC-2, pellet) was substituted for the PC resin composition-1.

### Example 17

A light reflection sheet was prepared in the same manner as in Example 14, except that in Example 14, the light stabilizer contained in the light-fast layer was changed to a hindered amine base light stabilizer (brand name: U Double UV-G301, manufactured by Nippon Shokubai Co., Ltd.).

### Example 18

A light reflection sheet was prepared in the same manner as in Example 14, except that in Example 14, the light stabilizer contained in the light-fast layer was changed to a benzophenone base UV absorber (brand name: HC-935UE, manufactured by Ipposha Oil Industries Co., Ltd.).

### Reference Example 1

The PC resin composition-1 (PC-1, pellet) was dried in a hot air oven on the conditions of 140° C. and 4 hours. The dried composition was used and extruded to a horizontal direction by means of an extruding apparatus having a 65 mmφ single shaft extruder equipped with a volatile remover, a gear pump and a coat hanger die having a width of 60 cm, and it was molded into a sheet by a vertical three cooling roll system to obtain the sheet having a thickness of 600 μm. In this regard, the cylinder temperature was 250 to 260° C.; the volatile removing pressure was −100.0 kPa (−750 mm Hg); the dice temperature was 210° C.; the roll temperatures were No. 1./No. 2/No. 3=120° C./150° C./170° C.; and the extruding amount was 30 kg/hour. A light-fast layer was not provided on the above sheet, and the light reflection sheet comprising only the base sheet was prepared.

### Reference Example 2

A light reflection sheet was prepared in the same manner as in Reference Example 1, except that in Reference Example 1, the PC resin composition-3 (PC-3, pellet) was substituted for the PC resin composition-1. A light-fast layer was not provided on the above sheet, and the light reflection sheet comprising only the base sheet was prepared.

### Comparative Example 11

A coating liquid prepared by diluting the light stabilizer (brand name: U Double UV-G12, manufactured by Nippon Shokubai Co., Ltd.) in a concentration of 20 mass % in terms of a solid content by diacetone alcohol was coated on one surface of the sheet prepared in Reference Example 1 to a thickness of 0.4 μm by means of a bar coater, and it was dried in a hot air oven on the conditions of 120° C. and 5 minutes to form a light-fast layer, whereby a light reflection sheet was prepared.

The light reflection sheets obtained in the examples, the comparative example and the reference examples each described above were evaluated by methods described below. The results thereof are shown in Table 3.

(1) Evaluating Method of Light Reflection Sheets

The light reflection sheet was irradiated in an energy amount of 20 J/cm² by means of a high pressure mercury lamp to measure a Y value and a color difference (ΔE) before and after irradiation by means of a spectrophotometer (LCM2020 Plus, manufactured by Macbeth Co., Ltd.), whereby the light-fastness was evaluated.

A D65 light source (visible light region wavelength) was used, and the Y value was measured on the condition of a viewing angle of 10 degrees to determine the reflectance (SCI) of 400 to 700 nm including specular reflection. The ΔE was measured on the condition of an F light source and a viewing angle of 10 degrees based on a non-irradiated sample. SCI is a reflectance measured including a surface glossiness (mirror reflection).

TABLE 3

| | | | | | | Reflectance | |
|---|---|---|---|---|---|---|---|
| | Light-fast layer | | Base sheet | | Light | Before | After |
| | | Thickness | | Thickness | fastness | irradiation | irradiation |
| | Material | (μm) | Material | (μm) | (ΔE) | (%) | (%) |
| Example 14 | UV-G12 | 5 | PC-1 | 600 | 4.7 | 98.6 | 98.3 |
| Example 15 | UV-G12 | 10 | PC-1 | 600 | 4.0 | 98.4 | 96.9 |
| Example 16 | UV-G12 | 5 | PC-2 | 600 | 6.5 | 97.8 | 95.3 |
| Example 17 | UV-G301 | 5 | PC-1 | 600 | 4.3 | 98.6 | 96.7 |
| Example 18 | HC-935UE | 5 | PC-1 | 600 | 3 | 98.5 | 97.1 |
| Reference | — | — | PC-1 | 600 | 15 | 98.7 | 92.1 |
| Example 1 | | | | | | | |
| Reference | — | — | PC-3 | 600 | 8 | 98.4 | 93.2 |
| Example 2 | | | | | | | |
| Comparative | UV-G12 | 0.4 | PC-1 | 600 | 11 | 98.6 | 93.3 |
| Example 11 | | | | | | | |

### Example 19

The light reflection sheet prepared in Example 15 was dried at 100° C. for 8 hours and then vacuum-molded in a spreading magnification of 1.2 at a sheet heating temperature of 180° C. to obtain a thermally molded article (508 mm (20 inch), a light reflection plate of a cold cathode eight lamp type) having corrugations shown in FIG. 1, in which an interval between the peaks of the adjacent corrugations was 38 mm and an interval between the bottom points of the adjacent corrugations was 18 mm and in which a height of the corrugation was 10 mm and a size was 30.4 cm×40 cm. The thermal moldability was good. This thermally molded article has 8 valleys formed by the adjacent corrugations as shown in FIG. 2 (3 valleys in FIG. 2), in which a length shown by L is 40 cm.

In the thermally molded article thus obtained, the light-fast layer had a thickness of 8 μm, and the base sheet had a thickness of 500 μm. The thermally molded article had a light fastness (ΔE) of 4.3, a reflectance of 98.5% before irradiation and a reflectance of 96.8% after irradiation.

### Example 20

The PC resin composition-1 (PC-1, pellet) was dried in a hot air oven on the conditions of 140° C. and 4 hours. The dried composition was used and extruded to a horizontal direction by means of an extruding apparatus having a 65 mmφ single shaft extruder equipped with a volatile remover, a gear pump and a coat hanger die having a width of 60 cm, and it was molded into a sheet by a vertical three cooling roll system to obtain the sheet having a thickness of 600 μm. In this regard, the cylinder temperature was 250 to 260° C.; the volatile removing pressure was −100.0 kPa (−750 mm Hg); the dice temperature was 210° C.; the roll temperatures were No. 1./No. 2/No. 3=120° C./150° C./170° C.; and the extruding amount was 30 kg/hour.

A dispersion prepared by dissolving an acryl base resin (brand name: Acrylpet MF, manufactured by Mitsubishi Rayon Co., Ltd.) in a mixed solvent of ethyl acetate/propylene glycol methyl ether=1/2 (mass ratio) in a concentration of 20 mass % in terms of a solid content, adding acryl cross-linked particles (brand name: MBX-5, average particle diameter: 5 μm, manufactured by Sekisui Plastics Co., Ltd.) of an amount corresponding to 10 mass % of the solid matters and dispersing them by stirring was coated on one surface of the sheet described above to a thickness of 5 μm by means of a bar coater, and it was dried in a hot air oven on the conditions of 120° C. and 5 minutes to form a light diffusion layer, whereby a light reflection sheet was prepared.

### Example 21

A light reflection sheet was prepared in the same manner as in Example 20, except that in Example 20, silica particles (brand name: Mizukasil, average particle diameter: 5 μm, manufactured by Mizusawa Industrial Chemicals, Ltd.) were substituted for the acryl cross-linked particles contained in the light diffusion layer.

### Example 22

A light reflection sheet was prepared in the same manner as in Example 20, except that in Example 20, a solution prepared by dissolving the light stabilizer (brand name: U Double UV-G12, manufactured by Nippon Shokubai Co., Ltd.) in propylene glycol methyl ether in a concentration of 20 mass % in terms of a solid content was substituted for the solution prepared by dissolving the acryl base resin in the mixed solvent in a concentration of 20 mass % in terms of a solid content.

### Example 23

A light reflection sheet was prepared in the same manner as in Example 22, except that in Example 22, acryl cross-linked particles (brand name: MBX-8, average particle diameter: 8 μm, manufactured by Sekisui Plastics Co., Ltd.) were substituted for the acryl cross-linked particles contained in the light diffusion layer and that a thickness of the light diffusion layer was changed to 8 μm.

### Example 24

A light reflection sheet was prepared in the same manner as in Example 20, except that in Example 20, styrene cross-linked particles (brand name: SBX-8, average particle diameter: 8 μm, manufactured by Sekisui Plastics Co., Ltd.) were substituted for the acryl cross-linked particles contained in the light diffusion layer and that a thickness of the light diffusion layer was changed to 8 μm.

### Example 25

A light reflection sheet was prepared in the same manner as in Example 20, except that in Example 20, the light stabilizer contained in the light diffusion layer was changed to the benzophenone base UV absorber (brand name: U Double HC-935UE, manufactured by Ippousha Oil Industries Co., Ltd.).

### Example 26

A light reflection sheet was prepared in the same manner as in Example 20, except that in Example 20, the PC resin composition-2 (PC-2, pellet) was substituted for the PC resin composition-1.

### Reference Example 3

The PC resin composition-1 (PC-1, pellet) was dried in a hot air oven on the conditions of 140° C. and 4 hours. The dried composition was used and extruded to a horizontal direction by means of an extruding apparatus having a 65 mmφ single shaft extruder equipped with a volatile remover, a gear pump and a coat hanger die having a width of 60 cm, and it was molded into a sheet by a vertical three cooling roll system to obtain the sheet having a thickness of 600 μm. In this regard, the cylinder temperature was 250 to 260° C.; the volatile removing pressure was −100.0 kPa (−750 mm Hg); the dice temperature was 210° C.; the roll temperatures were No. 1./No. 2/No. 3=120° C./150° C./170° C.; and the extruding amount was 30 kg/hour. A light-fast layer was not provided on the above sheet, and the light reflection sheet comprising only the base sheet was prepared.

### Comparative Example 12

A light reflection sheet was prepared in the same manner as in Example 20, except that in Example 20, the acryl cross-linked particles were not added to the light diffusion layer.

The light reflection sheets obtained in the examples, the comparative example and the reference example each described above were evaluated by the methods described above. The reflectance (SCE) of 400 to 700 nm including specular reflection was determined as well in addition to the reflectance (SCI) of 400 to 700 nm including specular reflection. SCE is a reflectance measured without including a surface glossiness (mirror reflection). The results thereof are shown in Table 4.

TABLE 4

| | Light diffusion layer | | | Base sheet | | Light | Reflectance (SCI) | | Reflectance* | | |
|---|---|---|---|---|---|---|---|---|---|---|---|
| | Acryl | | Thickness | | Thickness | fastness | Before | After | SCI | SCE | SCI − SCE |
| | base resin | Particle | (μm) | Material | (μm) | (ΔE) | irradiation | irradiation | (%) | (%) | (%) |
| Example 20 | Acrypet MF | MBX-5 | 5 | PC-1 | 600 | 10.5 | 98.4 | 93.5 | 98.4 | 96.5 | 1.9 |
| Example 21 | Acrypet MF | Mizukasil P510 | 5 | PC-1 | 600 | 11.2 | 98.2 | 93.2 | 98.2 | 96.2 | 2 |
| Example 22 | UV-G12 | MBX-5 | 5 | PC-1 | 600 | 4.3 | 98.3 | 97.1 | 98.3 | 96.1 | 2.2 |
| Example 23 | UV-G12 | MBX-8 | 8 | PC-1 | 600 | 5.1 | 98.1 | 97.3 | 98.1 | 96.2 | 1.9 |
| Example 24 | UV-G12 | SBX-8 | 8 | PC-1 | 600 | 5.8 | 97.9 | 96.9 | 97.9 | 95.9 | 2 |
| Example 25 | HC-935UE | MBX-5 | 5 | PC-1 | 600 | 4 | 98.6 | 97.5 | 98.6 | 96.3 | 2.3 |
| Example 26 | UV-G12 | MBX-5 | 5 | PC-2 | 600 | 6.5 | 97.5 | 96.5 | 97.5 | 93.8 | 3.7 |
| Reference | — | — | — | PC-1 | 600 | 13.1 | 98.7 | 92.1 | 98.7 | 94.4 | 4.3 |
| Example 3 | | | | | | | | | | | |
| Comparative | UV-G12 | — | 5 | PC-1 | 600 | 4.5 | 98.3 | 97.2 | 98.3 | 94.3 | 4.2 |
| Example 12 | | | | | | | | | | | |

*Not irradiated with a UV ray

### Example 27

The light reflection sheet prepared in Example 22 was dried at 100° C. for 8 hours and then vacuum-molded in a spreading magnification of 1.2 at a sheet heating temperature of 180° C. to obtain a thermally molded article (508 mm (20 inch), a light reflection plate of a cold cathode eight lamp type) having corrugations shown in FIG. 2, in which an interval between the peaks of the adjacent corrugations was 38 mm and an interval between the bottom points of the adjacent corrugations was 18 mm and in which a height of the corrugation was 10 mm and a size was 30.4 cm×40 cm. This thermally molded article has 8 valleys formed by the adjacent corrugations as shown in FIG. 2 (3 valleys in FIG. 2), in which a length shown by L is 40 cm.

In the thermally molded article thus obtained, the light diffusion layer had a thickness of 4 μm, and the base sheet had a thickness of 500 μm. The thermally molded article had a light fastness (ΔE) of 5.3 and reflectances (not irradiated with a UV ray) of 97.9% in terms of SCI, 97.2% in terms of SCE and 0.7% in terms of SCI-SCE.

### INDUSTRIAL APPLICABILITY

The light reflection sheet of the present invention is suited to reflection parts for light sources such as displays of a liquid crystal back light, lighting equipments, fluorescent lamps used in houses and various facilities, LED, EL, plasma and lasers.

1. A light reflection sheet (I) comprising a sheet having a thickness of 0.4 to 2 mm and comprising a polycarbonate resin composition containing (B) titanium oxide, wherein the above sheet has a light reflectance of 98% or more and a light transmittance of less than 1%.

2. The light reflection sheet as described in claim 1, wherein the polycarbonate resin composition comprises 85 to 60 mass % of (A) a polycarbonate base polymer and 15 to 40 mass % of (B) titanium oxide.

3. The light reflection sheet as described in claim 1, having a flame retardancy of a V-0 class in a thickness of 0.8 mm in a vertical flame retardant test according to a UL94 method.

4. A production process for the light reflection sheet as described in claim 1, comprising a step (1) of drying a polycarbonate resin composition containing 85 to 60 mass % of (A) a polycarbonate base polymer and 15 to 40 mass % of (B) titanium oxide at 120 to 140° C. for 2 to 10 hours, a step (2) of extruding it by means of an extruding machine equipped with a volatile removing device and a step (3) of molding it into a sheet at a dice temperature of 200 to 260° C. and a roll temperature of 120 to 180° C.

5. A molded article prepared by heating the light reflection sheet as described in claim 1 at a temperature of 160 to 200° C. and then thermally molding it at a spreading magnification of 1.1 to 2 times.

6. A molded article prepared by thermally molding the light reflection sheet as described in claim 1, wherein an unevenness in a thickness of a reflecting surface is 0.2 mm or less.

7. A light reflection sheet (II) prepared by providing a light-fast layer which cuts or absorbs a UV ray in a thickness of 0.5 to 20 μm on at least one face of a base sheet having a thickness of 0.4 to 2 mm and comprising a polycarbonate resin composition containing a combination of 85 to 60 mass % of (A) a polycarbonate base polymer and 15 to 40 mass % of (B) titanium oxide.

8. The light reflection sheet as described in claim 7, wherein the light-fast layer is constituted from an acryl base resin or a methacryl base resin copolymerized with at least one selected from a polymerizable light stabilizer component and a polymerizable UV absorber component.

9. The light reflection sheet as described in claim 8, wherein the polymerizable light stabilizer component and the polymerizable UV absorber component contain at least one selected from hindered amine base compounds, benzotriazole base compounds and benzophenone base compounds.

10. The light reflection sheet as described in claim 7, wherein a reflectance measured by irradiating the surface of the light-fast layer with light of a visible light region wavelength is 90% or more.

11. The light reflection sheet as described in claim 7, wherein a color difference (ΔE) between before and after irradiation which is observed when irradiating the surface of the light-fast layer with a UV ray in an energy amount of 20 J/cm² by means of a high pressure mercury lamp is 10 or less, and a reduction in a reflectance of visible light is 5% or less.

12. A molded article obtained by thermally molding the light reflection sheet as described in claim 7.

13. A light reflection sheet (III) prepared by providing a light diffusion layer which diffuses and reflects light in a thickness of 0.5 to 20 μm on at least one face of a base sheet having a thickness of 0.4 to 2 mm and comprising a polycarbonate resin composition containing a combination of 85 to 60 mass % of (A) a polycarbonate base polymer and 15 to 40 mass % of (B) titanium oxide.

14. The light reflection sheet as described in claim 13, wherein the light diffusion layer is a layer in which particles having an average particle diameter of 1 to 20 μm selected from organic particles and inorganic particles are dispersed in an acryl base resin or a methacryl base resin.

15. The light reflection sheet as described in claim 14, wherein the organic particles are particles selected from acryl base cross-linked particles and styrene base cross-linked particles; the inorganic particles are particles selected from silica and titanium oxide; and a content of the above particles is 0.5 to 50 mass % based on the light diffusion layer.

16. The light reflection sheet as described in claim 13, wherein a reflectance measured by irradiating the surface of the light diffusion layer with light of a visible light region wavelength is 90% or more.

17. The light reflection sheet as described in claim 13, wherein a difference between a total reflectance (SCI) measured by irradiating the surface of the light diffusion layer with light of a visible light region wavelength and a reflectance (SCE) obtained by deducting specular reflection from total reflection is 4% or less.

18. The light reflection sheet as described in claim 13, wherein the light diffusion layer contains at least one selected from a polymerizable light stabilizer component and a polymerizable UV absorber component, and the above components are selected from hindered amine base compounds, benzotriazole base compounds and benzophenone base compounds.

19. The light reflection sheet as described in claim 13, wherein a color difference (ΔE) between before and after irradiation which is observed when irradiating the surface of the light diffusion layer with a UV ray in an energy amount of 20 J/cm² by means of a high pressure mercury lamp is 10 or less, and a reduction in a reflectance of visible light is 5% or less.

20. A molded article obtained by thermally molding the light reflection sheet as described claim 13.
